(19) United States
(12) Patent Application Publication
(10) Pub. No.: US 2023/0315930 A1
(43) Pub. Date: Oct. 5, 2023

(54) Aircraft Requirement Creation and Design Validation System

(71) Applicant: Reliable Robotics Corporation, Mountain View, CA (US)

(72) Inventors: Jonathan Dring, Mountain View, CA (US); Robert J. Briody, Mountain View, CA (US); Christopher Schulenberg, Mountain View, CA (US)

(21) Appl. No.: 17/721,912

(22) Filed: Apr. 15, 2022

Related U.S. Application Data
(60) Provisional application No. 63/326,199, filed on Mar. 31, 2022.

(51) Int. Cl. G06F 30/15; G06F 30/12

(52) U.S. Cl. CPC G06F 30/15; G06F 30/12; G06F 2111/02

(57) ABSTRACT

System and graphical user interface for generating reference data objects that include a reference to immutable expectation content for an aircraft expectation file. Reference data objects are allocated to nodes of an allocation tree data structure which are referenced during creation of requirement data objects. Requirement data objects capture engineering requirement content for a portion of the aircraft and a link to one or more corresponding reference data objects from which immutable expectation content may be viewed through selection of the link. The systems and methods can be used to efficiently and accurately audit a set of requirements specified for a given aircraft with respect to a set of aircraft expectation files.

### CROSS-REFERENCE TO RELATED APPLICATION

This application is a nonprovisional and claims the benefit under 35 U.S.C. § 119(e) of U.S. Provisional Patent Application No. 63/326,199, filed Mar. 31, 2022, the contents of which are incorporated herein by reference as if fully disclosed herein.

### TECHNICAL FIELD

The present disclosure is generally directed to a graphical user interface for generating, tracking, and validating aircraft design, and, more specifically, to systems and methods for generating a graphical user interface for generating reference data objects, generating engineering requirement data objects, and establishing links between reference data objects and engineering requirement data objects for functional, operational, and/or structural aspects of an aircraft.

### BACKGROUND

Modern aircraft are highly complex systems that include numerous interacting systems, including sophisticated computers and avionics, mechanical systems, hydraulic systems, structural components, and the like. Such aircraft must satisfy numerous regulations, standards, laws, and operational requirements. For example, for an aircraft to be approved for certain flight operations, the aircraft must satisfy regulations relating to its operational capabilities, structural design, communications equipment capabilities, and the like. Some traditional validation tools can be difficult to use and navigate. It can also be difficult to visualize the impact of a change to a regulation or other constraint on a set of requirements that has been created for a given aircraft design.

### SUMMARY

A method may include, at a computing system comprising a processor and memory, obtaining an aircraft expectation document file containing immutable expectation content, and defining a reference data object, comprising receiving a designation of a location within the aircraft expectation document file, the location corresponding to selected immutable expectation content within the aircraft expectation document file, receiving information defining an expectation item associated with the selected immutable expectation content, and assigning a reference data object identifier to the reference data object. The method may further include storing the reference data object in a database and allocating the reference data object to a node of an allocation tree data structure. Allocating the reference data object may include obtaining a node identifier of the node of the allocation tree data structure, the node defining an operational objective of an aircraft and modifying the reference data object to include the node identifier. The method may further include generating a requirement data object defining an engineering requirement for a portion of the aircraft, including causing display of a requirement data object generation user interface on a client device, receiving a selection of the node of the allocation tree data structure, in response to receiving the selection of the node, causing display of a list of candidate expectation items from reference data objects associated with the node, receiving a selection of the expectation item from the list of candidate expectation items, in response to receiving a selection of the expectation item, storing a link to the expectation item in the requirement data object, receiving requirement content, and storing the received requirement content in the requirement data object. The method may further include, in response to receiving a request to view the requirement data object, causing display of the requirement content and causing display of the link to the expectation item, the link selectable to cause display of the reference data object that includes the expectation item.

The reference data object may be a reference data object of a plurality of reference data objects, each respective reference data object of the plurality of reference data objects may be associated with respective immutable expectation content within the aircraft expectation document file, and the method may further include receiving an audit request configured to evaluate compliance with at least the aircraft expectation document file, in response to receiving the audit request, analyzing the plurality of reference data objects to identify reference data objects that are not associated with any requirement data objects, and causing display of an audit graphical user interface, the audit graphical user interface including a graphical output identifying the reference data objects that are not associated with any requirement data objects. The method may further include, in response to receiving the selection of the expectation item, storing a link to the requirement data object in the reference data object.

The reference data object may include the expectation item and the reference data object identifier, and allocating the reference data object to the node of the allocation tree data structure may include associating the node identifier with the expectation item. The reference data object may further include at least one of information corresponding to the location of the selected immutable expectation content or an image corresponding to a portion of the aircraft expectation document file identified by the location of the immutable expectation content. The method may further include assigning an expectation item identifier to the expectation item.

The expectation item may be a first expectation item, the location of the selected immutable expectation content may be a first location of first selected immutable expectation content, and defining the reference data object may further include receiving a designation of a second location within the aircraft expectation document file, the second location corresponding to second selected immutable expectation content within the aircraft expectation document file, and receiving information defining a second expectation item associated with the second selected immutable expectation content.

The reference data object may be a reference data object of a plurality of reference data objects, each respective reference data object of the plurality of reference data objects may be associated with respective immutable expectation content within the aircraft expectation document file, the requirement data object may be a requirement data object of a plurality of requirement data objects, and the method may further include receiving an indication that expectation content of the immutable expectation content associated with the reference data object has changed, identifying a set of requirement data objects affected by the change in the expectation content, and graphically indicating, to the user, the set of requirement data objects that are affected by the change in the expectation content.

A method may include, at a computing system comprising a processor and memory, causing display of a first graphical user interface including a document image of an aircraft expectation document, receiving a user input identifying a selected region of the document image, capturing data corresponding to the selected region of the document image, causing an allocation tree data structure to be displayed in the first graphical user interface, the allocation tree data structure defining a plurality of nodes, respective nodes of the plurality of nodes corresponding to respective operational objectives of an aircraft, in response to a user selection of a node of the allocation tree data structure, generating a reference data object that includes an identifier of the selected node and the data corresponding to the selected region of the document image, in response to receiving a requirement data object generation request, generating a requirement data object, the requirement data object comprising an engineering requirement for a portion of the aircraft and a link to the reference data object, causing display of the requirement data object in a second graphical user interface, the requirement data object including the link to the reference data object, and in response to receiving a selection of the link to the reference data object, causing at least one of the reference data object or the selected region of the document image to be displayed to the user.

The reference data object may include an expectation item, and the link to the reference data object is a link to the expectation item. The expectation item may be a first expectation item, the reference data object may include a second expectation item, the requirement data object may be a first requirement data object, the link to the reference data object may be a link to the first expectation item, and a second requirement data object may include an additional engineering requirement for the portion of the aircraft and a link to the second expectation item.

The method may further include including the link to the reference data object in the requirement data object in response to a user selecting the reference data object for inclusion in the requirement data object. The method may further include, in response to detecting the user selection of the reference data object for inclusion in the requirement data object, modifying the reference data object to include a link to the requirement data object. The data corresponding to the selected region of the document image may be an image file.

A method may include, at a computing system comprising a processor and memory, causing display of a reference data object user interface, the reference data object user interface including a document image of an aircraft expectation document and a document portion capture control, receiving, via the document portion capture control, a user selection of a region of the displayed document image, the region including immutable expectation content within the aircraft expectation document, causing display of a node selection user interface including an allocation tree data structure defining a plurality of nodes, respective nodes of the plurality of nodes corresponding to respective operational objectives of an aircraft, receiving a selection of a node in the allocation tree data structure, receiving information defining an expectation item associated with the immutable expectation content, in response to receiving the selection of the node and the information defining the expectation item, generating a reference data object including an identifier of the selected node and the information defining the expectation item, causing display of a requirement data object user interface including a description field and a reference data object linking control, receiving, in the description field, an engineering requirement for a portion of the aircraft, receiving, via the reference data object linking control, a selection of an identifier associated with the expectation item, in response to receiving the selection of the identifier associated with the expectation item, generate a link to the reference data object that includes the expectation item, generating a requirement data object including the engineering requirement and the link to the reference data object that includes the expectation item, and causing display of the requirement data object, including causing display of the engineering requirement for the portion of the aircraft and the link to the reference data object, wherein selection of the link is configured to cause display of at least one of the reference data object or the selected region of the document image.

The reference data object linking control may display a list of candidate expectation items including the expectation item. The selection of the node may be a first selection of the node during a reference data object generation operation, and the method may further include receiving a second selection of the node during a requirement data object generation operation.

The candidate expectation items displayed in the reference data object linking control may be selected from reference data objects associated with the selected node of the allocation tree data structure. The method may further include, in response to receiving the second selection of the node during the requirement data object generation operation, prepopulating the requirement data object with information from the selected node. The method may further include, in response to receiving the second selection of the node during the requirement data object generation operation, prepopulating the requirement data object with information from a reference data object associated with the selected node.

A non-transitory computer readable storage medium may store one or more programs, the one or more programs comprising instructions, which when executed by an electronic device, cause the electronic device to perform any of the methods described herein.

A computer system may include one or more processors, memory, and one or more programs stored in the memory and configured to be executed by the one or more processors and including instructions for performing any of the methods described herein.

### BRIEF DESCRIPTION OF THE DRAWINGS

In the drawings:

FIG. 1 depicts an example aircraft for which engineering requirements may be developed for aircraft design and/or modification.

FIG. 2A depicts an example system for generating and auditing data objects related to aircraft regulations and corresponding engineering requirements for validation of an aircraft design.

FIG. 2B depicts an example networked computer system in which various features of the present disclosure may be implemented.

FIG. 3 depicts an example graphical user interface for generating reference data objects related to aircraft regulations.

FIGS. 4A-4B depict an example graphical user interface for capturing immutable regulation content from aircraft regulation document files.

FIGS. 5A-5E depict an example graphical user interface for generating reference data objects related to aircraft regulations.

FIGS. 6A-6C depict example graphical user interfaces for generating requirement data objects and linking requirement data objects to reference data objects.

FIG. 6D depicts an example graphical user interface for viewing and editing reference data objects related to aircraft regulations, and viewing links between reference data objects and requirement data objects.

FIGS. 7A-7C depict example graphical user interfaces for displaying audit results related to regulation audits and change audits.

FIG. 8 depicts an example process for generating reference data objects and requirement data objects for an aircraft design.

FIG. 9 depicts an example process for generating and displaying audit results.

FIG. 10 depicts an example electrical block diagram of an electronic device that may perform the operations described herein.

While the invention as claimed is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION OF THE EMBODIMENTS

In the following description numerous specific details are set forth in order to provide a thorough understanding of the claimed invention. It will be apparent, however, that the claimed invention may be practiced without these specific details. In some instances, well-known structures and devices are shown in block diagram form in order to avoid unnecessary obscuring.

The present disclosure is generally directed to systems and methods for managing, tracking, and/or validating compliance with stakeholder expectations during design and construction of an aircraft or a retrofit or modification of an aircraft. For example, when designing an aircraft or a modification of an aircraft, the aircraft must satisfy numerous stakeholder expectations. Stakeholder expectations refer to any rules, regulations, laws, guidance, or other governing principles with which an aircraft must ultimately comply. Example stakeholder expectations include laws and regulations, industry standards, aircraft manuals, aircraft component manuals, or the like, and may take the form of documents that are stored within a system. The documents that correspond to or define the stakeholder expectation documents may contain immutable expectation content.

During design, testing, manufacture, and validation of the aircraft or the modification or retrofit of the aircraft, it is necessary to ensure that all applicable stakeholder expectations are complied with. For example, aircraft designers must ensure that every applicable federal regulation, industry standard, or other selected set of expectations is satisfied by some component, structure, and/or operational capability of the aircraft. Further, aircraft designers must account for changes or updates to the stakeholder expectations. For example, any aircraft components, structures, and/or operational capabilities that are affected by a change in an expectation must be updated to account for those changes. Aircraft designers must also ensure that any changes to the components, structures, and/or operational capabilities of the aircraft do not affect the aircraft's compliance with all applicable stakeholder expectations.

Described herein are systems and methods that associate stakeholder expectations with aircraft components, structures, and/or operational capabilities to help ensure that the aircraft complies with the applicable expectations. The systems and methods also determine how changes in expectations affect the components, structures, and/or operational capabilities of the aircraft, and determine how changes in the components, structures, and/or operational capabilities of the aircraft affect compliance with applicable expectations. The systems described herein also provide graphical user interfaces that allow users to quickly visualize how these changes affect the overall project, and to efficiently navigate to immutable expectation content that is implicated by a change.

For example, a computer system may include a set of stakeholder expectation document files, which may be non-editable files of industry standards, regulations, manuals, or any other document selected as a stakeholder expectation document. The documents may be used as immutable references for a set of reference data objects created using an interface described herein. The system may also include an allocation tree data structure made up of nodes that each represent or define a functional or operational objective of an aircraft (or specify aircraft components, component operations, and/or physical structures of the aircraft). The allocation tree data structure may be stored as a JSON file, YAML file, XML file, or other data object or file capable of storing and/or representing hierarchical node structures or schema. Nodes of the allocation tree data structure may be referred to as allocation nodes (or optionally function nodes).

The system allows a user to capture screenshots or location data (e.g., location coordinates within a document) of a desired portion of the stakeholder expectation document. The system then allows the user to create data objects that include the screenshots (or the locations of the identified document portions) and links to or identifiers of nodes in the allocation tree data structure that relate to the expectation in the screenshot. Thus, for example, an aircraft designer can capture a screenshot of a regulation (e.g., “tires for a landing gear shall have a load rating sufficient to support the maximum aircraft weight”), and select a node from the allocation tree associated with landing gear tires (e.g., “Section 2.1.2. Landing Gear”). The system may then generate a data object that includes the captured screenshot (and optionally other information about that regulation) and a link to or other identifier of the selected node.

In some cases, the allocation tree data structure may act as an index or guide for the development of the engineering requirements for the aircraft, and can be used to associate the expectations that were allocated to the nodes of the allocation tree with the engineering requirements that are ultimately generated. For example, the nodes of the allocation tree data structure may correspond to the functions and/or operations the aircraft must perform, components or other physical aspects of the aircraft, and/or other objectives, while the engineering requirements may define the actual specifications, components, software, programs, or the like, that will provide or achieve the functions and/or objectives specified in the allocation tree data structure. When an engineer is generating the engineering requirements, the engineer may select a node from the allocation tree in order to launch or pre-populate portions of an engineering requirement (or the node may be associated with engineering requirements in a different way, such as with a linking engine that automatically determines and/or predicts relationships between engineering requirements and reference data objects), and the expectation items that were allocated to the selected allocation tree node may be associated with the engineering requirement. Further, associating the expectation items with the engineering requirements may include defining a link between the expectation items and the engineering requirements, such that the engineering requirements identify (and link to) the expectation items that they address or satisfy, and the expectation items identify (and link to) the engineering requirements that have been created in order to satisfy or address the expectation item.

The linking between expectation items and engineering requirements facilitates various auditing and validation techniques. For example, the system can analyze the reference data objects and their expectation items to determine whether all of the expectation items have been addressed by an engineering requirement. Further, if the engineering requirements are changed, the system can analyze the system data to determine which expectation items (if any) are affected by the changes to the engineering requirements. Similarly, if an expectation is changed, the system can analyze the system data to determine which engineering requirements are affected by the changes. The results of these analyses may be presented to an engineer, allowing them to easily and efficiently determine how changes affect the overall validation landscape of the aircraft. Such analyses may be provided for actual changes to the system data (e.g., an actual change to an FAA regulation), and for hypothetical changes (e.g., an engineer determining whether changing a specification on a radio component will affect the aircraft's regulatory compliance). These and other features and concepts are described herein.

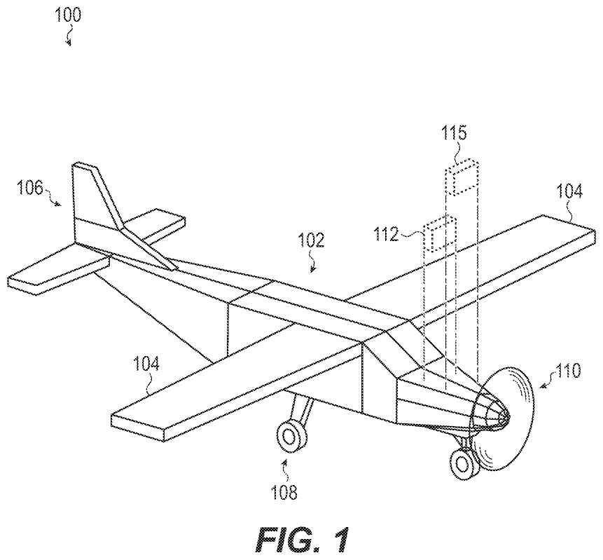

FIG. 1 illustrates an example aircraft 100. The aircraft 100 may represent an aircraft that is being designed, built, validated, or otherwise analyzed using the systems and methods described herein. The systems and methods described herein may be used for various stages of aircraft design, development, or modification. The systems and methods may be used to validate a new design for a new aircraft, or to validate modifications that are being made to an existing aircraft. In the latter case, such modifications may affect the components and functions of the aircraft that are subject to regulation and/or other stakeholder expectations. For example, in some cases, it may be desirable to modify an existing aircraft to include autonomous, semi-autonomous, or remote-operation capabilities. In such cases, critical systems, such as avionics 112, may be replaced or modified, which may implicate laws and regulations that govern the design and use of the aircraft. Further, supplemental operational systems 115 may be added to the aircraft 100 to facilitate the new functionality, also implicating those laws and regulations. The supplemental operational systems 115 may include additional or different avionics, computer systems, electronic and/or mechanical components, and the like. In some cases, the supplemental operational systems 115 may be configured to add autonomous, semi-autonomous, or remote-operation capabilities to the aircraft.

The aircraft 100 may include a fuselage 102, wings 104, a tail section 106, landing gear 108, a propulsion system 110 (which may include a propeller, rotor, motor, turbine, etc.), and avionics 112. The aircraft may also include supplemental operational systems 115 that are to be added to the aircraft to enable new flight functionalities, and for which additional validation and/or compliance analysis must be performed. The aircraft 100 may include flight control surfaces for controlling pitch, roll, and yaw or other aerodynamic or operation parameters of the aircraft 100, such as elevators, rudders, ruddervators, ailerons, stabiliators, flaps, and the like.

The aircraft 100 may be configured for (or may be modified or retrofitted to enable) fully autonomous, semi-autonomous, and/or manually-operated flight modes, and may be configured for unmanned flight, remotely operated or monitored flight, or manned flight. The avionics 112 and optional supplemental operational systems 115 may be configured to facilitate any one or multiple combinations of these flight paradigms. Further, as noted above, the supplemental operational systems 115 may be used to increase the capabilities of the aircraft 100, such as by adding systems and/or components to add a new flight paradigm to the aircraft (e.g., adding a fully-autonomous, unmanned flight paradigm).

As noted above, the structural and functional specifications of the aircraft 100 may be governed by regulations or other stakeholder expectations. For example, regulations, industry standards, or other expectations may apply to the structure and/or function of the fuselage 102, wings 104, tail section 106, landing gear 108, propulsion system 110, avionics 112, and supplemental operational systems 115.

While FIG. 1 illustrates the aircraft 100 as a fixed-wing, propellor-driven aircraft, this is merely an example, and the systems and methods described herein may apply to other types of aircraft (or other vehicles) as well, including but not limited to rotorcraft (e.g., helicopters, multi-rotor aircraft), jet-driven aircraft, vertical take-off and landing (“VTOL”) aircraft, rockets, ships, automobiles, and the like.

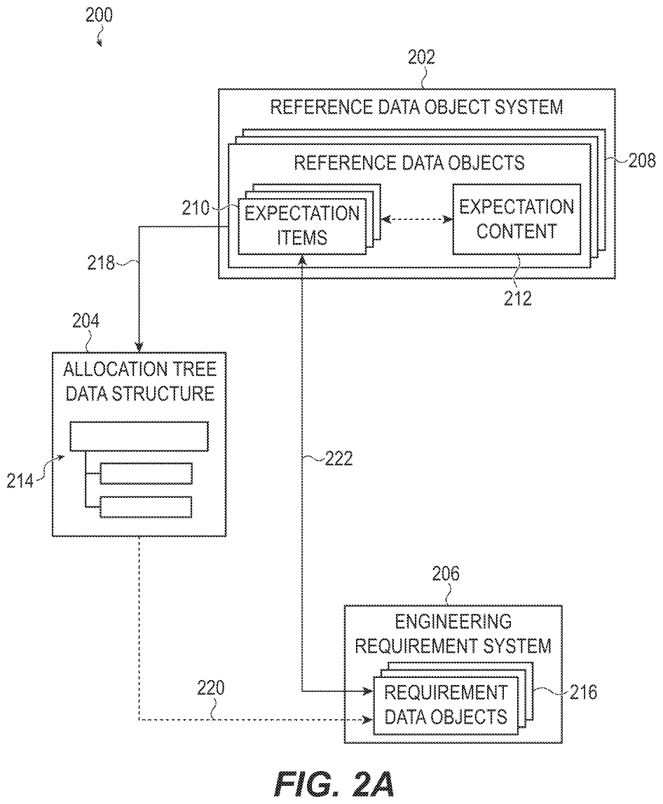

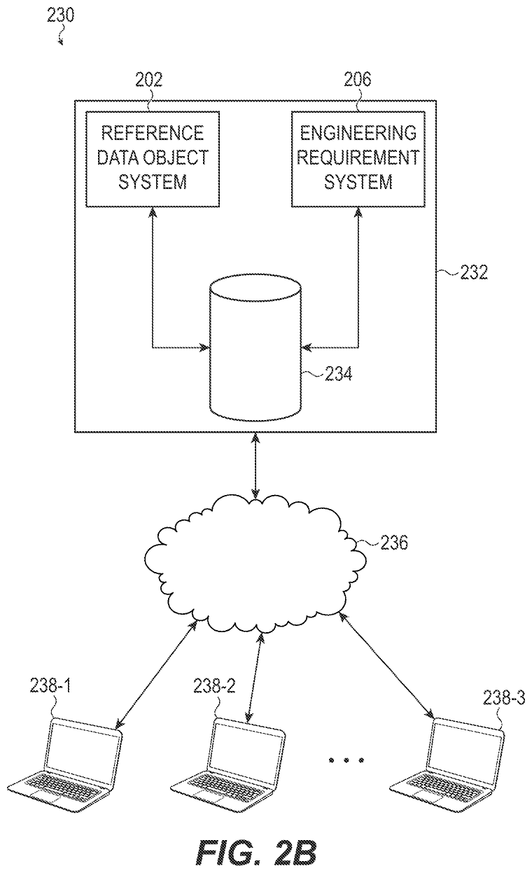

FIG. 2A illustrates a schematic view of a system 200 for facilitating the design and validation of an aircraft, as described herein. The system 200 includes a reference data object system 202 (“RDO system 202”), an allocation tree data structure 204, and an engineering requirement system 206 (“ER system 206”). FIG. 2A illustrates how system data may be organized and linked within the system 200 to facilitate the design and audit functionalities described herein. As used herein, system data includes data associated with the system and used by the system 200, including but not limited to reference data objects, regulation items, engineering requirements, expectation document files, and indexes and/or trees representing other items or objects.

The RDO system 202 may include reference data objects 208. The reference data objects 208 may be stored as stored and/or instantiated as files, data structures, or the like. For example, the reference data objects 208 may be XML files, YAML files, JSON files, or any other suitable file, data structure, or data object that includes immutable expectation content (e.g., screenshots or images of actual expectation documents), and, as described herein, links to nodes of an allocation tree data structure and links to associated requirement objects 216 (which define engineering requirements for the aircraft). Reference data objects 208 may associate expectation content with other system data, and they are used by the system 200 to facilitate analyzing and auditing the system data to ensure that the aircraft is in compliance with the expectations. Reference data objects may serve as a representation, in the system 200, of an expectation (e.g., a regulation, industry standard, or the like) or portion thereof.

The reference data objects 208 may include (or be associated with) expectation items 210 and expectation content 212. Expectation items 210 may be stored as part of the data structure or data object that defines the reference data object, or they may be stored separately (e.g., as separate data structures or data objects from their parent reference data object).

Expectation content 212 may include expectation document files associated with selected stakeholder expectations. Stakeholder expectations refer to any rules, regulations, laws, guidance, or other governing principles with which an aircraft must ultimately comply. Example stakeholder expectations include aircraft regulations (e.g., FAA regulations), laws, advisory documents (e.g., FAA advisory circulars), industry standards, manuals, specifications, handbooks, or any other content that has been established for a project as a stakeholder expectation (e.g., a user-generated list of expected aircraft functions, or the like).

The particular stakeholder expectations that are applicable to a given project (e.g., an aircraft design, retrofit, and/or modification project) may be selected by an individual or entity that is designing the aircraft or otherwise managing the project. To the extent that stakeholder expectations are added, removed, or changed in a given project, the systems and methods described herein may help ensure that the changes are accounted for in the final aircraft specification.

The expectation document files may be or may include immutable expectation content. The immutable expectation content may be stored and presented in a format that is not editable or modifiable within the system 200. For example, aircraft expectation document files include regulations, laws, and/or other expectations that have been established for a given aircraft project, which must be complied with and which are not typically under the authority of users of the system 200. Accordingly, the system 200 does not allow users to modify or change the expectation document files, as doing so may result in the aircraft failing to be compliant with applicable expectations. In some cases, the expectation document files may be stored as an image or other non-editable or immutable document, such that it cannot be altered or adjusted via the system 200.

The expectation content 212 may also include user-defined screenshots, snippets, or other sub-division of the expectation document files, which may be associated with individual reference data objects 208 and/or expectation items 210. For example, as described in greater detail herein, a user may use a document portion capture control (e.g., a screenshot or screen grab tool) to capture an image of a portion of an expectation document file. The captured portion may correspond to a regulation, industry standard, or any other expectation content (or a section or subsection thereof). Captured portions of an expectation document file may be associated with reference data objects 208 and/or expectation items 210 of the reference data objects 208.

The system 200 also includes an allocation tree data structure 204 that may be stored as a JSON file or other similarly structured schema configured to represent a hierarchical node or element data structure. As indicated by arrow 218 in FIG. 2A, reference data objects 208 may also be associated with nodes 214 in the allocation tree data structure 204. For example, a user may create a reference data object 208 in order to generate, in the system 200, a representation of a particular expectation from an expectation document in the system 200. The reference data object 208, and/or an expectation item 210 of a reference data object 208, may be allocated to a particular node 214 of the allocation tree data structure 204. Thus, for example, a user may create a reference data object 208 related to a regulation pertaining to landing gear tires. The user may capture a screenshot of the portion of the document containing the text of the associated regulation, and also allocate the reference data object 208 to a node in the allocation tree data structure that relates to landing gear tires. As a result, the system data of the system 200 includes a searchable, trackable, and analyzable data structure that includes the immutable expectation content (e.g., the screenshot of the regulation) and links it to a particular structure or function of the aircraft.

By linking reference data objects 208 to nodes 214 of the allocation tree data structure 204, expectations can be associated with a structure or function of an aircraft. However, the allocation tree data structure 204 does not define the engineering requirements or specifications of the aircraft design. Accordingly, the system 200 includes an engineering requirement system 206 that allows a designer to create requirement data objects 216, and link the requirement data objects 216 to the reference data objects 208 (and/or expectation items 210), thereby associating actual engineering specifications of the aircraft to the expectation content via the reference data objects 208. For example, as described herein, a user may use an engineering requirement user interface to generate a requirement data object 216. The system may allow the user to generate a requirement data object 216 by selecting or otherwise referring to a node of the allocation tree data structure 204 (e.g., by selecting a “create requirement from node” button in a view of the allocation tree data structure 204), as indicated by arrow 220. In such cases, the system 200 may pre-populate or recommend content related to the selected node in the requirement data object 216. For example, the system 200 may pre-populate a title or description of the requirement data object 216 with text from a title of the selected node 214. As another example, the system 200 may pre-populate the requirement data object 216 with a link to and/or identifier of one or more reference data objects 208 and/or expectation items 210 that were allocated to the node from which the requirement data object is being generated. In some cases, a user manually inputs data for the requirement data object 216, including manually identifying and including links to and/or identifiers of reference data objects 208 and/or expectation items 210.

In some cases, even if the user does not manually specify or otherwise associate a node 214 of the allocation tree data structure 204 to a requirement data object 216, the system 200 may automatically determine nodes 214 that may relate to a requirement data object 216, and propose candidate reference data objects 208 and/or expectation items 210 to be linked to the requirement data object 216 being created or edited. For example, a user may generate a requirement data object 216 and input a title (e.g., “tires”). The system 200 may analyze the allocation tree data structure 204 (e.g., using a linking engine that employs a predictive model, string searching, topic analysis algorithms, or any other suitable technique) to identify nodes that may relate to tires, and automatically recommend reference data objects 208 and/or expectation items 210 that are linked to the identified nodes.

Whether reference data objects 208 and/or expectation items 210 are manually selected, automatically populated, or recommended for inclusion in a requirement data object 216, a user may select one or more reference data objects 208 and/or expectation items 210 for the requirement data object 216. By selecting a reference data object 208 and/or expectation item 210 for a requirement data object 216, a link 222 from the requirement data object 216 to the reference data object 208 and/or expectation item 210 may be automatically defined. The link 222 may be instantiated by incorporating pointers to the linked objects. For example, in response to the user selecting a reference data object 208 and/or expectation item 210 for inclusion in a requirement data object, the reference data object 208 and/or expectation item 210 may be automatically modified to include a link to or identifier of the linked requirement data object 216, and the requirement data object 216 may also be automatically modified to include a link to or identifier of the linked reference data object 208 and/or expectation item 210.

Thus, the links 222 define relationships between stakeholder expectations (e.g., aircraft regulations, industry standards, operational guidelines, etc.) and engineering requirements. The system 200 can analyze the links 222 (and associated data objects) to provide validation and compliance analyses, such as to ensure that all expectations are addressed by at least one engineering requirement. Further, the system 200 can analyze the links and associated data objects to predict or show how a change in expectations may affect the aircraft structure or function, and how a change to the aircraft structure or function may affect the aircraft's compliance with expectations.

The requirement data objects 216 may be stored as stored and/or instantiated as files, data structures, or the like. For example, the requirement data objects 216 may be XML files, YAML files, JSON files, or any other suitable file, data structure, or data object that includes the data and/or information of a requirement data object.

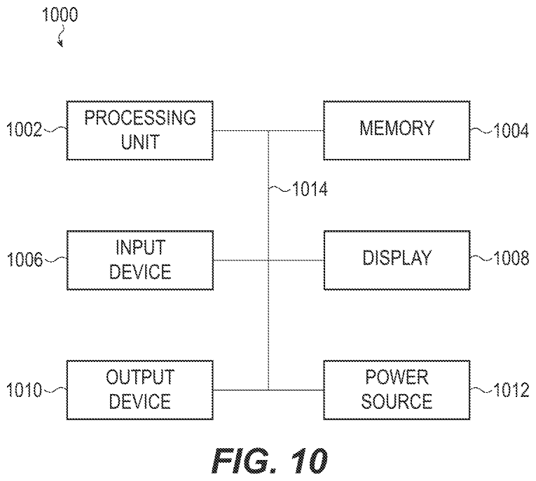

The system 200 illustrated in FIG. 2A may be implemented by one or multiple computing systems, including one or more server computers, client computers, databases, and the like. For example, the reference data object system 202 and the engineering requirement system 206 may be instantiated by one or more client or server computers, and data structure such as the reference data objects 208, the allocation tree data structure 204, and the requirement data objects 216 (and/or any other associated data, databases, and/or data structures) may be stored on the one or more client or server computers, or on separate storage systems. Further, the computing systems instantiating the system 200 and storing associated data may be or may include cloud-based computing services, accessible by one or more client devices. FIG. 10 herein illustrates an example computing system 1000 that may execute or instantiate the system 200 and its associated data.

FIG. 2B depicts an example networked computer system 230 (or simply “system 230”) in which the techniques described herein may be employed. The system 230 includes a design and validation platform 232 and client devices 238 (238-1, . . . , 238-n) that communicate via a network 236 (e.g., the Internet). The client devices 238 may be any suitable type of device, including but not limited to a desktop or laptop computer, tablet computer, mobile phone, personal digital assistant, smart device, voice-based digital assistant, or the like.

The design and validation platform 232 may be or may include one or more servers, content stores (e.g., databases), communications systems, data structures, programs, or other components, systems, or subsystems that provide services described herein, including services associated with the reference data object system 202 and the engineering requirement system 206. In particular, the design and validation platform 232 may include the reference data object system 202, the engineering requirement system 206, and a data store 234. The data store 234 may store content associated with the reference data object system 202 and the engineering requirement system 206, including stakeholder expectation documents, allocation tree data structures, reference data objects, expectation items, expectation content, requirement data objects, immutable expectation content (e.g., image files of screenshots), and any other data structures, data objects, files, or data used, generated, and/or accessed by the systems of the design and validation platform 232.

The platform 232 may also store (e.g., in the data store 234) user information of users of the platform 232. User information may include, for example, user credentials, roles, titles, authorizations and/or permissions, and the like. In some cases, certain functions of the platform 232 are only accessible to users having a certain authorization level. For example, as noted herein, stakeholder expectations are generally fixed for a given project, and should not be modified, changed, removed, or added to without proper authorization. Accordingly, in some cases, the platform 232 only permits read-only access to the stakeholder expectation documents, unless a user has sufficient privileges (e.g., project administrator privileges, as compared to standard user privileges). The platform 232 may also tailor other services and/or functionalities based on user information, as described herein. For example, the types of content that may be recommended to a user may be based at least in part on the role and/or title of that user.

The client devices 238 may allow users to communicate with the design and validation platform 232 to create reference data objects 208, link reference data objects 208 to engineering requirement data objects 216, perform expectation audits, and/or perform other functions and operations described herein.

The design and validation platform 232 may allow multiple client devices 238 (and thus multiple users) to access the platform 232 simultaneously. Thus, for example, a user of one client device 238-1 may access the platform 232 to generate reference data objects and allocate reference data objects to allocation nodes 214 in the allocation tree data structure 204, while a user of a second client device 238-2 may access the platform 232 to generate requirement data objects 216 (from the allocation tree data structure, as described herein) and define links between the requirement data objects 216 and the reference data objects 208. In this way, the platform 232 may facilitate simultaneous generation and linking of multiple different types of data objects, using the allocation tree data structure 204 as a fixed or static reference for a given project.

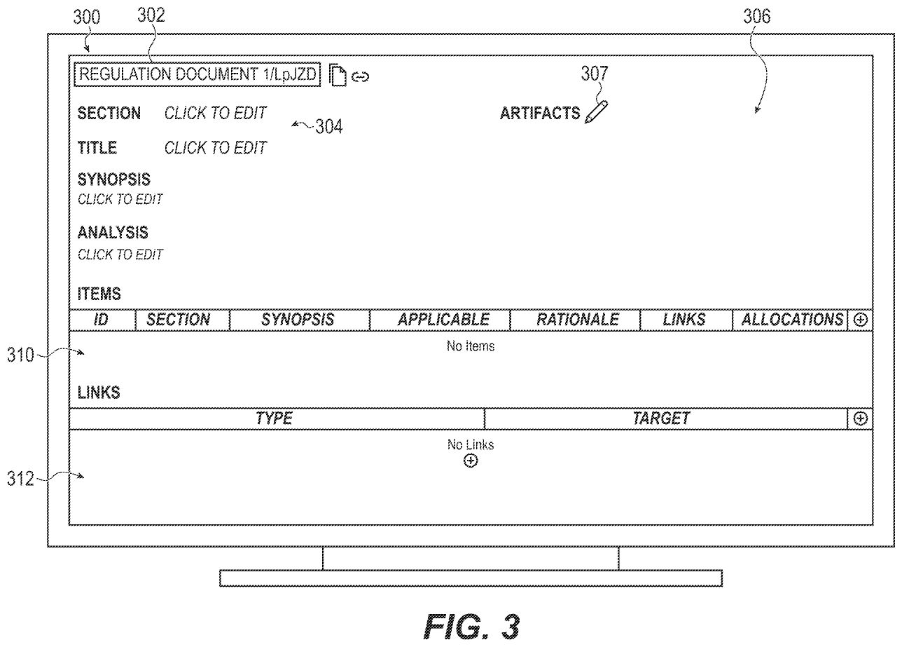

FIGS. 3-9 illustrate various examples of systems, methods, and graphical user interfaces for managing, tracking, and/or validating compliance with stakeholder expectations. For ease of illustration and discussion, these examples are directed towards aircraft design and relate to capturing aircraft regulation content (e.g., immutable regulation content) from aircraft regulation document files. However, this is merely one example industrial field and one example type of stakeholder expectation with which the instant systems and methods may be used. As noted herein, other types of expectation document files may be used instead of or in addition to aircraft regulation document files, and other types of immutable expectation content may be captured instead of or in addition to immutable regulation content. Further, the described systems, methods, and graphical user interfaces may be used for projects in other industries, such as shipping, aerospace, medical and pharmaceutical, and the like.

FIG. 3 illustrates an example reference data object user interface 300, which may be used to generate reference data objects 208 and/or expectation items 210, and to capture portions of aircraft expectation document files (e.g., aircraft regulation document files). As used herein, a user interface (also referred to as a “graphical user interface”) may be displayed on a display device, which may instantiate or be coupled to one or more component(s) of the system 200, which may be instantiated by one or more client computer system(s), server computer system(s), cloud-based computer system(s), or various combinations thereof.

The user interface 300 illustrates a single reference data object for illustration purposes, but the user interface 300 may be used to display multiple reference data objects, and may allow users to navigate among multiple reference data object and multiple expectation document files.

The user interface 300 may include a title field 302, which includes a unique identifier of a reference data object being generated. The title of a reference data object may include a textual reference to the particular aircraft regulation document file to which the reference data object relates, as well as a string (e.g., “LpJZD” in FIG. 3) that uniquely identifies the reference data object within the system 200. As described herein, assigning unique, nonsequential strings to identify data objects in the system 200 helps reduce the likelihood of transcription or typographical errors causing incorrect links between data objects. In some cases, the system assigns a unique identifier to every reference data object, and the assigned unique identifier is not editable by the user. In some cases the title of the reference data object may be automatically generated by the system upon receiving a request to create a new reference data object from an aircraft regulation document file.

The user interface 300 may also include a content section 304, which may provide one or more user-editable fields for accepting information about the reference data object. As shown, the content section 304 includes a section field, title field, synopsis field, and analysis field, though these are merely example fields, and more, fewer, or different fields may be used. A user may populate the fields with information about the regulation(s) (or other stakeholder expectation(s)) to which the reference data object applies.

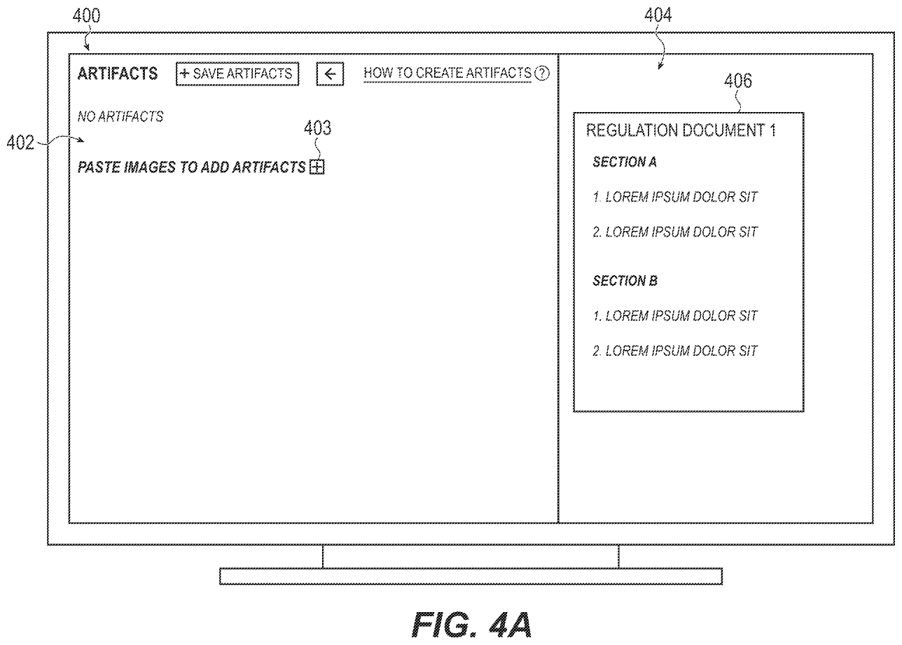

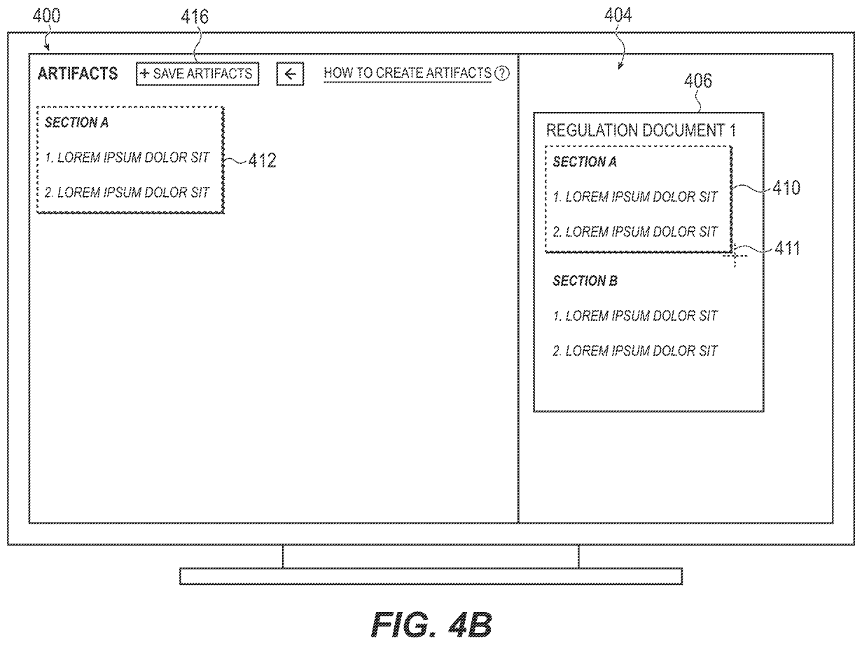

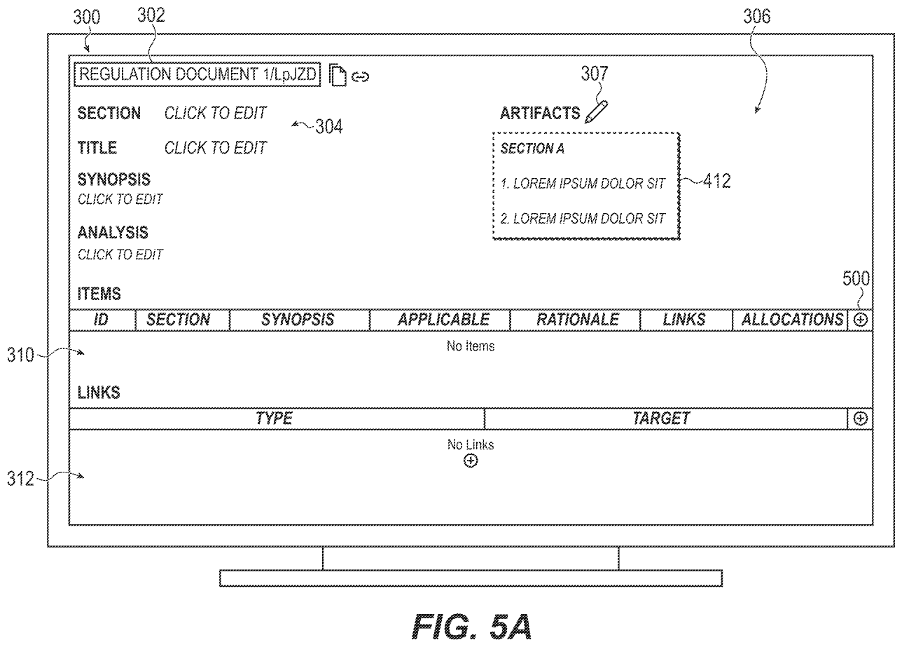

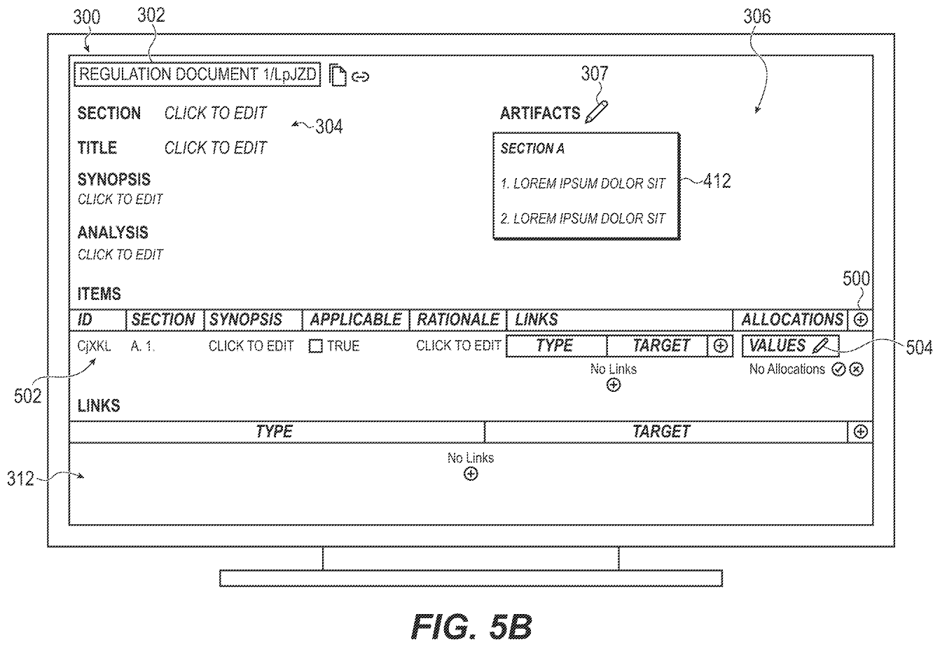

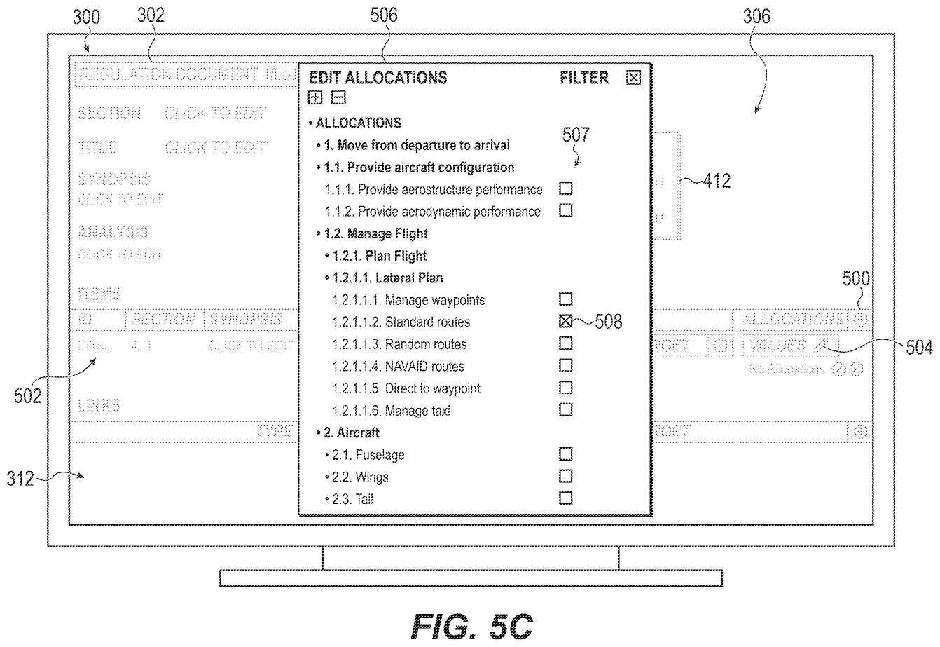

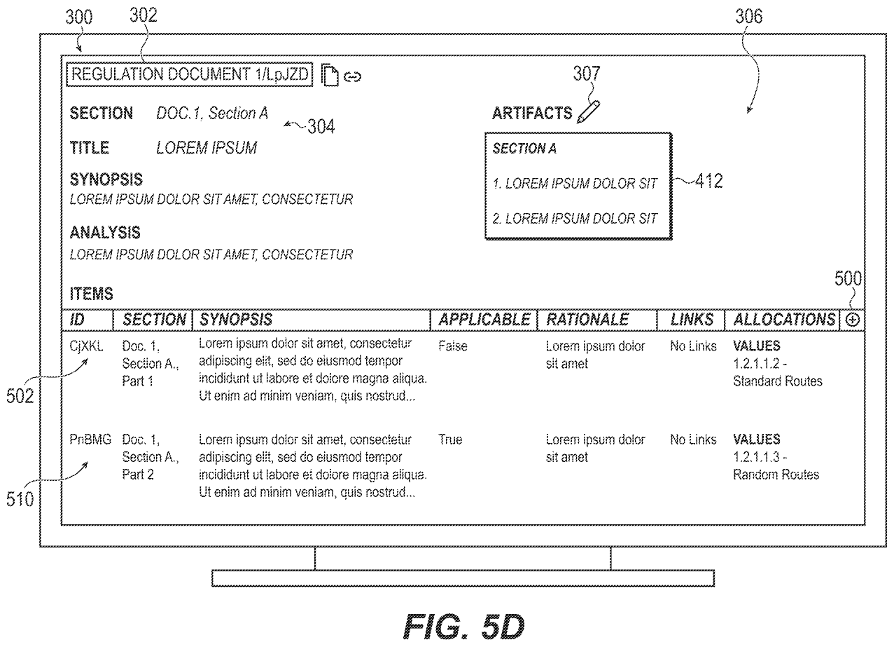

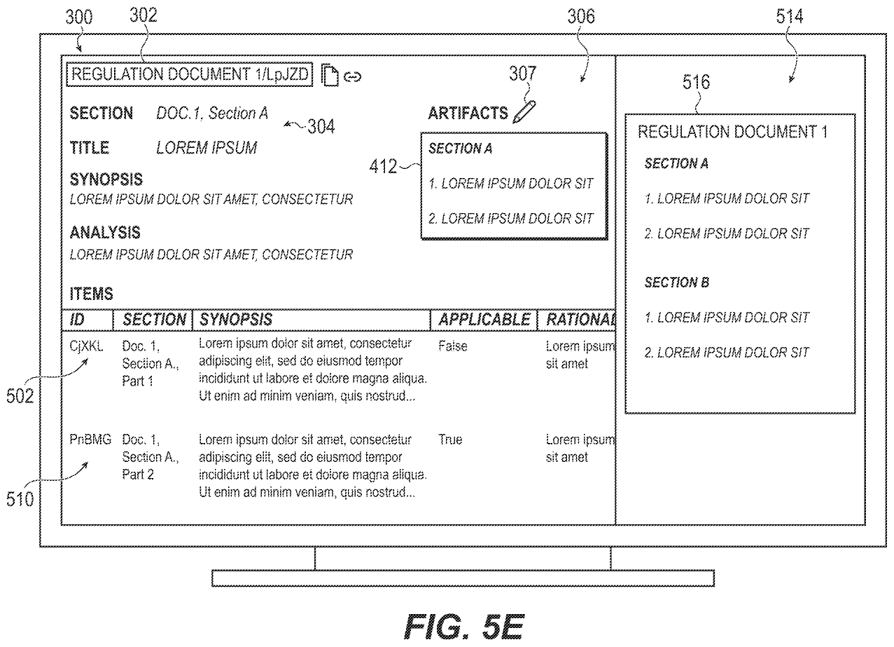

The user interface 300 may also include an expectation item section 310. The expectation items section 310 may display expectation items (e.g., expectation items 210) that have been generated within the reference data object, and accept user inputs to initiate the generation of new expectation items within the reference data object. As shown in FIG. 3, no expectation items have been generated within the reference data object. FIGS. 4A-5E illustrate how expectation items may be generated and displayed in the user interface 300.

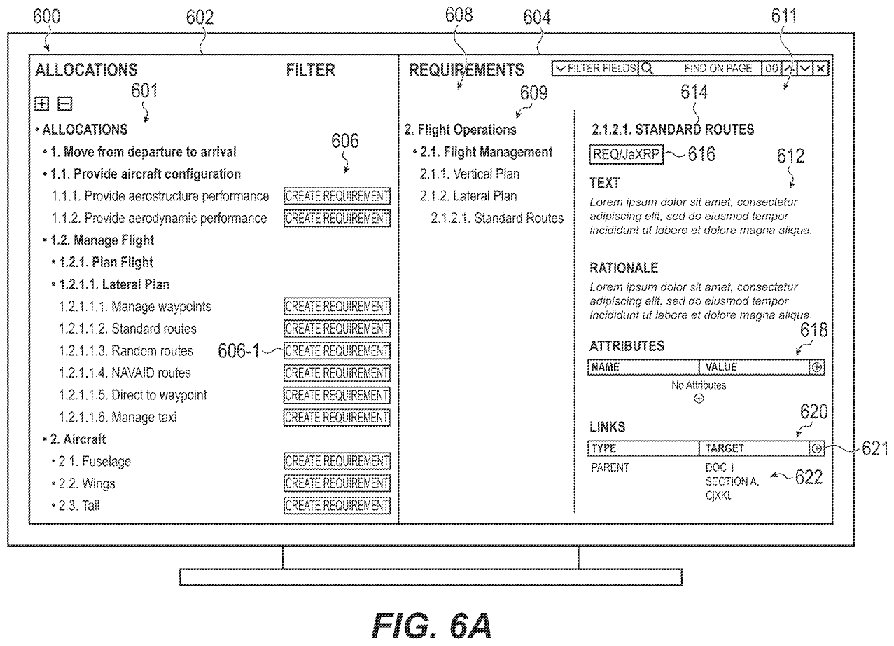

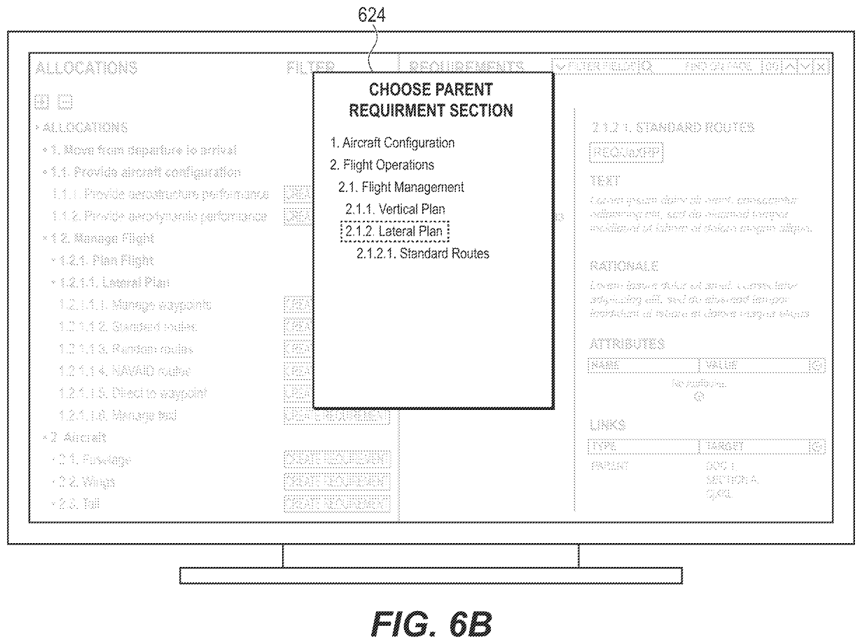

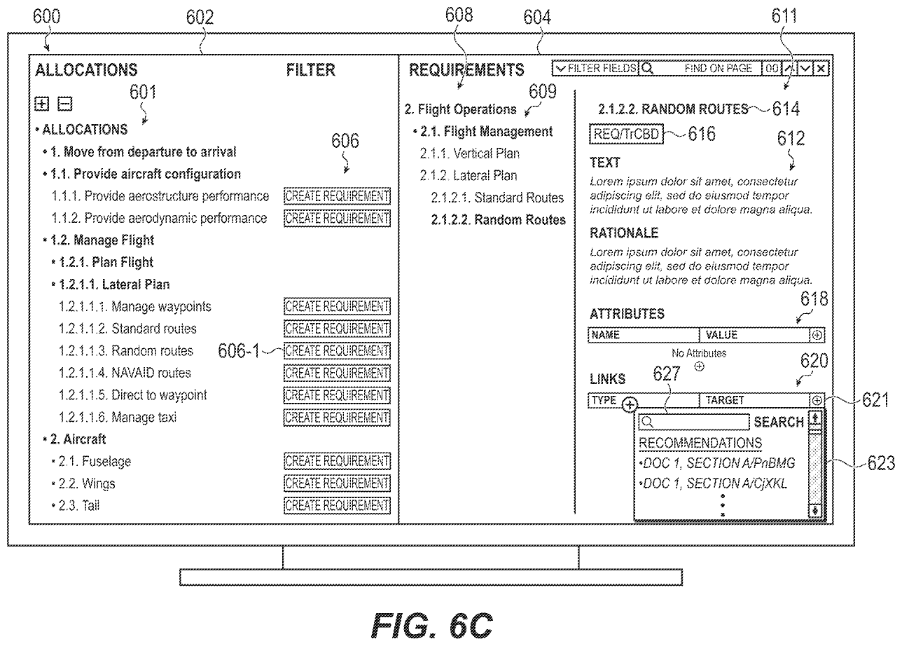

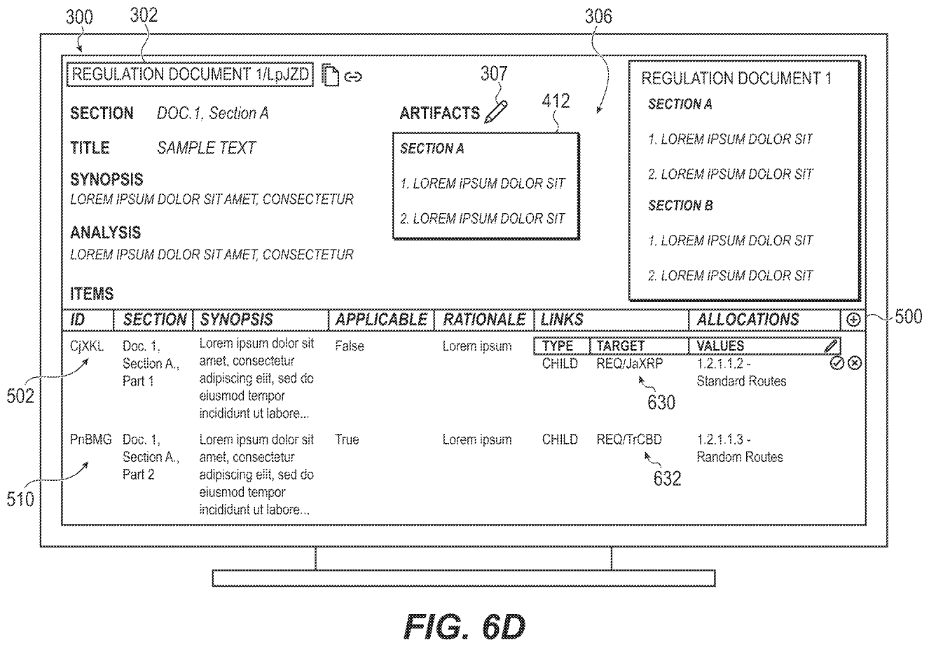

The user interface 300 may also include an engineering requirement links section 312. The engineering requirement links section 312 may display identifiers and/or links to engineering requirement data objects (e.g., requirement data objects 216) that have been linked to the reference data object, and accept user inputs to initiate the generation of new links between the reference data object and engineering requirement data objects. As shown in FIG. 3, there are no links between requirement objects and the reference data object. FIGS. 6A-6D illustrate how such links may be generated and displayed in the user interface 300.

The user interface 300 also includes a document artifact region 306 that displays artifacts (e.g., screenshots, screen grabs, snippets, etc.) from an aircraft regulation document file. As shown in FIG. 3, no artifacts have been generated or associated with the reference data object. FIGS. 4A-5A illustrate how artifacts may be generated and/or captured, and how they may be displayed in the user interface 300.

FIG. 4A illustrates a document portion capture user interface 400 (also referred to as the document capture interface 400). The document capture interface 400 may be displayed in response to a user selection of a document capture initiation input object 307 (FIG. 3) or other selectable element in the user interface 300. The document capture interface 400 allows users to select portions or regions of a document image that contain immutable regulation content and associate those portions or regions of the document (and thus the immutable regulation content that they contain) with a reference data object.

As shown in FIG. 4A, the document capture interface 400 includes an artifact region 402 and a document image display region 404. The document image display region 404 displays an aircraft regulation document file or a portion thereof (e.g., a page). As described herein, an aircraft regulation document file is one example of a stakeholder expectation document file. The aircraft regulation document file may be a non-editable file or representation, such that users of the system cannot change or edit the content of the aircraft regulation document file. More particularly, because the aircraft regulation document file relates to the authoritative expectations that the aircraft must satisfy in order to be compliant, the content should not be editable or changeable by users of the system who lack suitable authorization. Further, ensuring that the aircraft regulation document files (or any other expectation document files) are not subject to unrestricted editing by users ensures that designers can always return to an authoritative version of the regulation.

To add an artifact to the reference data object, a user may select an add-artifact input object 403. In response, a document portion capture control may be provided, as illustrated in FIG. 4B, which may include an image capture cursor 411. Using the image capture cursor 411, a user can select a region or portion of the aircraft expectation document file (e.g., the aircraft regulation document file) that contains immutable expectation content (e.g., immutable regulation content) of interest. The immutable expectation content of interest may be regulation content that is relevant to the reference data object being generated. Upon receiving the user selection of the region 410 of the displayed document image 406, the system may display an artifact 412, which may be an image or representation of the captured region 410 in the artifact region 402. The user may then review the artifact 412 and make changes (e.g., discard, re-capture, edit, etc.) to the artifact 412, as necessary. The user may capture any number of artifacts, depending on what immutable regulation content is to be included in or is relevant to the reference data object being generated. For example, while FIG. 4B illustrates a single artifact capturing two regulation segments (e.g., section A.1. and section A.2.), the user may instead capture each segment in its own artifact. Further, the user may also select a second artifact to capture the region of the aircraft regulation document file that includes “Section B.” Once the desired artifacts are captured (e.g., once the user has identified all of the desired regions of the aircraft regulation document file that contain the relevant immutable regulation content), the user may return to the reference data object user interface 300 (e.g., by selecting a “save artifacts” input object 416, or any other suitable technique).

The artifact 412, which is ultimately included in the reference data object (e.g., stored in or otherwise associated with the data structure that constitutes the reference data object), may be an image file (e.g., a jpeg, tiff, png, or any other suitable image file), or it may be represented by a location in the aircraft regulation document file. For example, the artifact 412 may be stored as coordinates or other data that define the location and/or area within the aircraft regulation document file. Where the artifact 412 is stored as data representing the location or area within an aircraft regulation document file, the system may retrieve an image of the location or area when a representation of the artifact 412 is to be displayed.

FIG. 5A illustrates the reference data object user interface 300 after an artifact 412 is captured for inclusion in the reference data object. As shown in FIG. 5A, a representation of the artifact 412 is displayed in the document artifact region 306. If multiple artifacts were captured by a user, all (or a subset) of the captured artifacts may be displayed in the document artifact region 306.

A user may use the reference data object user interface 300 to add information to the reference data object. For example, a user may add expectation items to the reference data object, such as by selecting an add expectation item input object 500. Expectation items may be part of the reference data object (e.g., they may be stored in or otherwise associated with the data structure that constitutes the reference data object). Reference data objects may include zero or more expectation items, and each expectation item may refer to a user-defined portion of the expectation document file. In some cases, each expectation item corresponds to individual sentences or the lowest organizational division of a stakeholder expectation, though the exact relationship between expectation items and the stakeholder expectations may be defined by a user.

In response to receiving a user input corresponding to a request to add an expectation item (e.g., a user selection of the input object 500), the user interface 300 may generate a new expectation item for the reference data object, including displaying expectation item content for the expectation item 502 in the expectation item section 310. The expectation item content may be supplied by a user, and/or it may be automatically populated in response to the system receiving the request to add the expectation item. Where the expectation item content is user-supplied, the user may click on a user input field (e.g., a text input field, check box, radio button, etc.) in a column in the expectation item section 310 and manually input text or other information. For example, the user may select an input field in the “section” column and insert the regulation section to which the expectation item applies (e.g., Section A.1.).

In some cases, at least a subset of the information associated with the expectation item may be assigned and/or pre-populated. For example, in response to receiving the request to add an expectation item, the system may assign a unique identifier (e.g., “CjXKL”) to the expectation item. Each expectation item may be assigned a unique identifier by the system, which may be non-editable by users.

In some cases, the system may also analyze the artifact(s) associated with the reference data object to extract other relevant information to include in the expectation item. For example, the system may perform optical character recognition on the artifact to extract textual content (e.g., text from the immutable regulation content, regulation section headings, etc.) and may apply textual analysis (e.g., natural language processing) to extract or identify subjects, topics, or other information about the artifact. Such information may be pre-populated in columns of the expectation item, or may be provided as recommendations to a user for inclusion in the expectation item. In some cases, the system does not attempt to interpret or extract information from the artifacts and/or the documents from which artifacts are captured.

The user interface 300 may also facilitate the allocation of expectation items (and/or the reference data object more generally) to nodes of an allocation tree data structure. As described above, the nodes of an allocation tree data structure may represent or define operational objectives of an aircraft, including, for example, structures and/or components that the aircraft must have and/or the functions that those structures, or the aircraft more generally, must perform.

In some cases, in order to facilitate selection of nodes of the allocation tree data structure, the user interface 300 may display the allocation tree data structure in an allocation tree data structure region 506, as shown in FIG. 5C. The allocation tree data structure may be displayed in response to a user selection of an input object 504 for adding allocations to the reference data object.

The allocation tree data structure may be stored as a JSON or other structured schema or data structure. The allocation tree data structure region 506 may display the allocation tree data structure as an expandable hierarchical list, with selection objects 507 (e.g., check boxes) associated with nodes of the allocation tree data structure. In some cases, selection objects 507 are only included for terminal nodes (e.g., the lowest level nodes in the hierarchy), while in other cases selection objects are included for non-terminal nodes as well. A user may select any number of selection objects 507 to associate the related node with the expectation item. For example, FIG. 5C illustrates the selection box 508, associated with the node “1.2.1.1.2 Standard Routes,” having been selected by a user. The user may also use the allocation tree data structure region 506 to remove node selections from an expectation item as well.

FIG. 5D illustrates the reference data object user interface 300 after a user has entered information defining the reference data object and two expectation items 502 and 510. Further, FIG. 5D shows the first expectation item having been allocated to a first node of the allocation tree data structure (e.g., the node titled “1.2.1.1.2 Standard Routes”), and the second expectation item having been allocated to a second node of the allocation tree data structure (e.g., the node titled “1.2.1.1.3 Random Routes”). While FIG. 5D illustrates each expectation item associated with only a single node, each expectation item may be allocated to multiple nodes. Further, while FIG. 5D illustrates the two expectation items of a reference data object being allocated to different nodes, in some cases all expectation items of a reference data object are allocated to the same nodes or combination of nodes.

As described above, the system described herein allows aircraft designers and engineers to easily and efficiently view immutable expectation content (e.g., the immutable regulation content in the examples shown) that are relevant to an aircraft design. For example, if a user wants to review the regulation content associated with a particular operational objective of an aircraft, the user may navigate to a reference data object that has been allocated to the node associated with the particular operational objective. (In some cases, the user may view an allocation tree data structure link index, in which a selection of a node of the allocation tree data structure causes the reference data object(s) associated with that node to be displayed). FIG. 5D, for example, illustrates both the user-generated content of the reference data object and the requirement items, and also shows the representation of the artifact 412 so that the user can see the immutable expectation content without having to resort to an external reference.

In some cases, the representation of the artifact 412 may also act as a link to the aircraft regulation document file. For example, as shown in FIG. 5E, a user can select the representation of the artifact 412 (e.g., by clicking on the representation or an associated input object), to cause the user interface 300 to display an aircraft regulation document file display region 514 with a representation of the aircraft regulation document file 516 (or a portion thereof). Thus, for example, if a user wishes to review the official source document of the artifact 412 (e.g., to confirm that the artifact 412 fully captures the expectation, or to view the expectation in its full context, or for any other reason), the user can simply select the artifact 412 to view the full aircraft regulation document file. The aircraft regulation document file may also be searchable and/or navigable in the aircraft regulation document file display region 514.

As described herein, the allocation tree data structure may be used to generate engineering requirements for the aircraft design. FIG. 6A illustrates an example user interface 600 that may facilitate the creation of engineering requirements using the allocation tree data structure. The user interface 600 includes a node selection user interface or region 602 and a requirement data object user interface 604.

The node selection user interface 602 displays the allocation tree data structure 601 (or a portion thereof), with which a user may consult when generating engineering requirements in the requirement data object user interface 604.

The requirement data object user interface 604 displays a requirement data object navigation region 608 and a requirement data object region 611. The requirement data object navigation region 608 includes an index or list 609 of the requirement data objects for a given project. The requirement data objects for a project may be related to the nodes in the allocation tree data structure in that a requirement data object defines engineering requirements and/or specifications that achieve operational objectives that are represented by the nodes in the allocation tree data structure. However, there is not necessarily a one-to-one relationship between nodes in the allocation tree data structure and requirement data objects. Further, the hierarchy of nodes in the allocation tree data structure may differ from those in the index of the requirement data objects.

The requirement data object user interface 604 in FIG. 6A illustrates an example requirement data object that has already been generated by a user. The requirement data object includes a title 614 (e.g., “2.1.2.1. Standard Routes”) as well as a unique identifier 616 that uniquely identifies the requirement data object within the system (e.g., “REQ/JaXRP”). The title 614 may include an identifier of the node, section, heading, or location of the requirement data object in the index of the requirement data objects.

The requirement data object user interface 604 also includes one or more description fields 612 that a user may populate with information, such as a textual description of the engineering requirement of the requirement data object, a rationale for the requirement data object (e.g., how the engineering requirement satisfies an operational objective of the allocation tree data structure), and the like. The requirement data object user interface 604 also includes an attributes region 618 that may list attributes associated with the requirement data object, and a links region 620.

The links region 620 includes links to (and other information about) the reference data objects that the engineering requirement is intended to satisfy or address. For example, as noted above, the reference data objects include immutable expectation content with which an aircraft must comply. Every reference data object therefore must be addressed by at least one engineering requirement, thereby ensuring that each expectation (e.g., regulation) has been addressed in the final specification of the aircraft. FIG. 6A shows the requirement data object having a link 622 to the expectation item “Doc 1, Section 1, CjXKL,” which is one of the expectation items in the reference data object shown in FIGS. 5A-5E (e.g., “Regulation Document 1/LpJZD”). Accordingly, the requirement data object in FIG. 6A is linked to the expectation item CjXKL (and thus also to the reference data object “LpJZD”). Once this link is established in the requirement data object, the reference data object may also be updated to include a complementary link to the requirement data object. For example, as shown in FIG. 6D, the first expectation item (“CjXKL”) in the reference data object (“LpJZD”) has a link to the “REQ/JaXRP” requirement data object). FIG. 6A illustrates a single link between the requirement data object and a reference data object (or expectation item of a reference data object), though this is merely one example, and a requirement data object may have more or fewer links. In some cases, an engineering requirement does not address any expectations, and may have no links to reference data objects.

In some cases, the allocation tree data structure 601 in the node selection user interface 602 is view-only, and is provided simply for a visual reference or guide. In some cases, the node selection user interface 602 includes requirement data object creation controls 606 associated with the nodes of the allocation tree data structure. A user selection of a requirement data object creation control 606 may cause a new requirement data object to be automatically generated (and displayed) based on the associated node and, optionally, automatically pre-populated with data from the selected node of the allocation tree data structure and/or reference data objects associated with the node. For example, a user may initiate the generation of a requirement data object associated with the “1.2.1.1.3. Random Routes” node of the allocation tree data structure by selecting the requirement data object creation control 606-1 (or any other selectable object associated with the node, such as the text of the node). An associated requirement data object may be automatically generated, optionally pre-populated with data from or associated with the selected node, assigned a unique identifier (as described herein), and displayed in a requirement data object user interface 604.

In response to receiving the selection of the node in the allocation tree data structure, the requirement data object user interface 604 may initiate an operation to generate an associated requirement data object. For example, as shown in FIG. 6B, the requirement data object user interface 604 may automatically display a requirement tree selection window 624. The user may select a section or node of the requirement object tree or index shown in the window 624 to indicate where the new requirement should be located within the hierarchy. For example, FIG. 6B illustrates a user having selected “2.1.2. Lateral Plan” as the parent node for the new requirement data object. In this example, the system may generate a new requirement data object under the “2.1.2. Lateral Plan” node (and may assign it to the next available sub-node, in this case 2.1.2.2.).

FIG. 6C illustrates the requirement data object user interface 604 after the user has selected a parent requirement node (or otherwise selected the location in the requirement data object hierarchy for the new requirement data object). In some cases, at least some of the information for the requirement data object may be pre-populated (or suggested) by the system. For example, the system may assign the unique identifier (e.g., “TrCBD”) to the requirement data object. Further, as noted above, the generation of the requirement data object shown in FIG. 6C may have been initiated by a user selecting a node in the allocation tree data structure. More particularly, as shown in FIG. 6A, the user initiated the requirement data object generation operation by selecting the node associated with “Random routes.” Accordingly, as shown in FIG. 6C, the title of the requirement data object may be pre-populated, such as with the title or other information of the selected node in the allocation tree data structure.

Information that is included (e.g., pre-populated) in the requirement data object may also be sourced from reference data objects that are associated with the selected allocation node in the allocation tree data structure. More particularly, the system may identify a reference data object that was previously associated with the selected allocation node (e.g., by searching the reference data objects to identify any that have been allocated to the selected allocation node, or by consulting an index or relational data structure that stores associations between allocation nodes and reference data objects, or any other suitable technique). Information from a reference data object associated with the allocation node, such as technical descriptions, synopses, titles, rationales, or any other associated data or information, may be used to pre-populate the requirement data object (or to suggest proposed information for inclusion in the requirement data object).

The system may also pre-populate or suggest links between reference data objects and a requirement data object being generated by a user, using the already-defined relationships between reference data objects and allocation nodes. With reference to the example in the figures, the user initiated the creation of the requirement data object in FIG. 6C by selecting the “1.2.1.1.3. Random Routes” node in the allocation tree data structure (see FIG. 6A). Further, as noted above, a reference data object (or an expectation item of a reference data object) was already allocated to or otherwise associated with this allocation node. In particular, as shown in FIG. 5D, the allocation node “1.2.1.1.3 Random Routes” was allocated to the expectation item with the unique identifier “PnBMG.” Accordingly, the user's selection of the allocation node when generating the requirement data object can be used to search for and/or otherwise identify expectation items and/or reference data objects that the requirement data object should be linked to. Thus, as shown in FIG. 6C, the system may pre-populate or recommend that the requirement data object be linked to “DOC. 1, SECTION A/PnBMG” (which corresponds to one of the expectation items in the reference data object that was allocated to the allocation node that was ultimately used to launch the operation of generating the requirement data object).

In some cases, the link to the expectation item “PnBMG” may be pre-populated in the links section of the requirement data object. In other cases, the system may not pre-populate links, but instead may recommend or suggest links when a user selects a reference data object linking control 621 (e.g., a button or other input object that can be selected to add a link in a requirement data object to a reference data object and/or an expectation item of a reference data object). For example, as shown in FIG. 6C, upon detecting a selection of the reference data object linking control 621, a link selection region 623 may be displayed. The link selection region 623 may include a list (which may be formatted as a drop-down menu or list) of recommendations of reference data objects and/or expectation items that may be relevant to the requirement data object (where the recommendations may be generated based on the allocation node that was initially selected when generating the requirement data object, as described above). The link selection region 623 may also include a search field 627 to allow a user to search for reference data objects and/or expectation items that should be linked to the requirement data object. A user may search for reference data objects and/or expectation items by unique identifier (e.g., if the user knows that the requirement data object for “Random Routes” should be linked to the expectation item PnBMG, the user may type in that string to retrieve a link to that expectation item).

When the system recommends or pre-populates data or information (e.g., for the recommendations in the link selection region 623, or other instances in the present application in which the system automatically recommends or pre-populates data), it may do so based at least in part on a characteristic of the active user. Thus, for example, the system may determine a role, title, or other characteristic of the user to whom the information or data is being automatically provided (e.g., by consulting user information stored in the data store 234 of the platform 232), and generate recommendations and/or select data that are specific to that particular user (e.g., that user's role, title, etc.). Thus, for example, the recommendations and/or data that are provided to an engineer may be different than those provided to a design engineer.

While the system may use the user's selection of the allocation node to determine which reference data objects and expectation items to pre-populate or recommend, other techniques are also possible. For example, the system may employ a linking engine to identify suggestions of reference data objects and/or expectation items. As one example, information that a user enters into a requirement data object may be used as an input to a predictive model or other algorithm employed by the linking engine (e.g., a string searching algorithm, topic analysis algorithm, or the like). The linking engine may analyze system data, such as the reference data objects, expectation items, allocation tree data structure, or any other suitable data, to determine potentially relevant reference data objects and/or expectation items to propose. As one highly simplified example, a user may supply the title “Random Routes” to the requirement data object in FIG. 6C. Using this as an input to the linking engine (e.g., to the predictive model of the linking engine), the system may query the reference data objects and/or expectation items to identify potentially relevant ones to suggest. Other data may also or instead be used to identify potential suggestions. For example, text from a description or information field of a requirement data object (e.g., from the “Text” or “Rationale” field in FIG. 6C) may be used as input to the linking engine. The linking engine may use techniques such as natural language processing to identify reference data objects and/or expectation items that may be relevant, such as by querying fields of those data structures (e.g., synopses, rationales, analyses, etc.), to find similar subject matter.

As described herein, when a requirement data object is linked to a reference data object (and/or an expectation item of a reference data object), the linked reference data object may be updated to include a complementary link to the requirement data object. Thus, for example, once the link to the expectation item “PnBMG” is added to the requirement data object in FIG. 6C, the reference data object containing that expectation item is updated to include a link to the requirement data object “TrCBD.” FIG. 6D illustrates the reference data object with updated links to the requirement data objects that were associated with the expectation items. In particular, the expectation item “CjXKL” has been updated to include a link 630 to the requirement data object “JaXRP,” and the expectation item “PnBMG” has been updated to include a link 632 to the requirement data object “TrCBD.” As described herein, the links between requirement data objects and expectation items (and/or their parent reference data objects) may be used to validate an aircraft design and/or ensure compliance with expectations, as well as to assist in visualizing the ways in which expectation changes may affect engineering specifications (and vice versa).

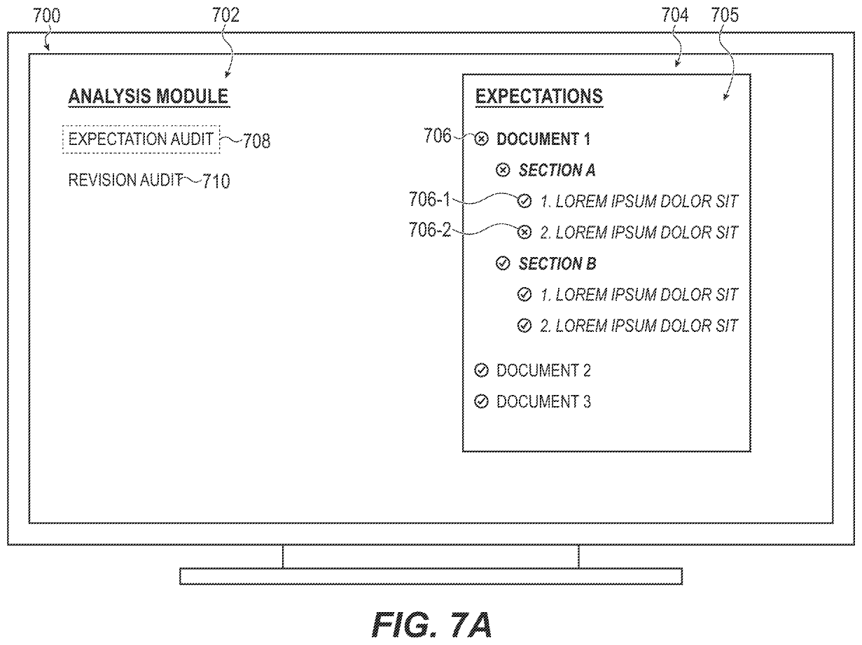

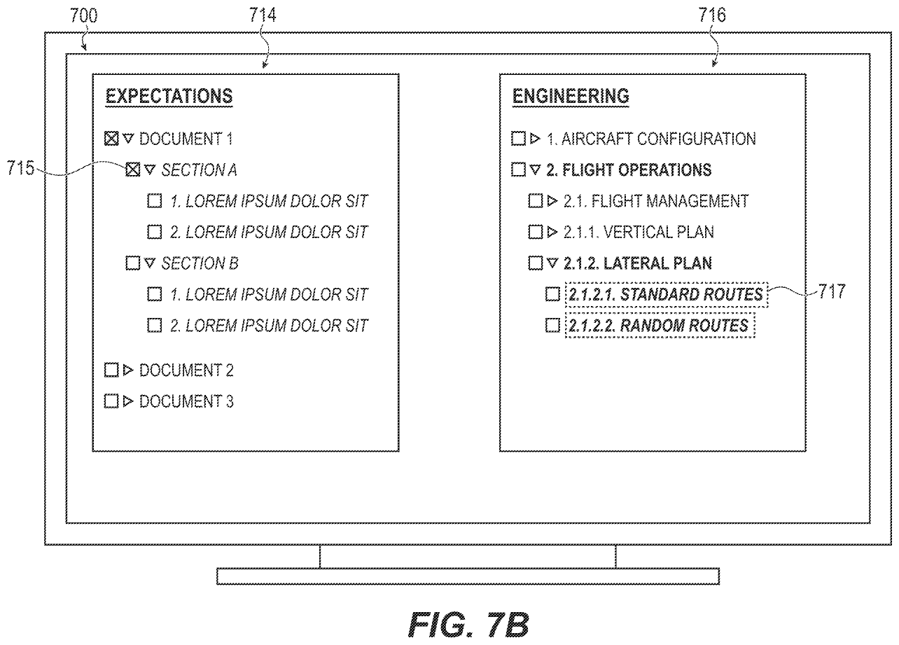

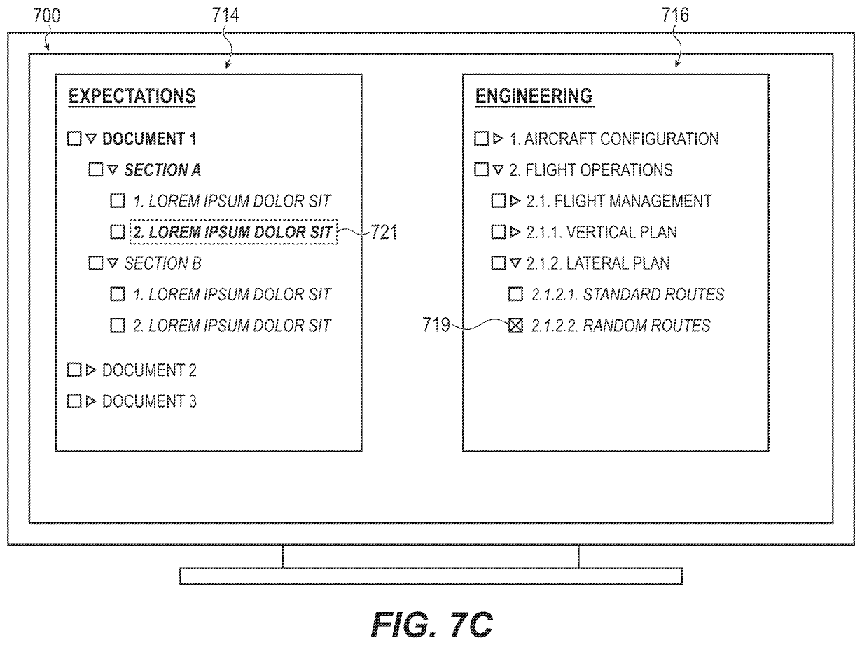

FIG. 7A illustrates an example expectation audit user interface 700. The user interface 700 may allow a user to initiate several different types of audits, validations, and other system-data analysis operations. For example, as described herein, the instant system allows aircraft designers to link requirement data objects and expectation items to help ensure that all expectation items have been addressed by at least one engineering requirement. Accordingly, the user interface 700 allows a user to select an expectation audit option 708 (from a list of audit options in a selection region 702), which causes the system to perform an expectation audit. Performing the expectation audit includes analyzing the reference data objects and/or expectation items to determine which reference data objects and/or expectation items have been linked to engineering requirements, and which have not. Results of the audit may be displayed to the user in a result region 704.

The expectation audit results may be displayed in various ways. As shown in FIG. 7A, the audit results are displayed in the context of an expectation tree 705. The expectation tree 705 may include sections for each aircraft expectation document file from which reference data objects have been obtained, and may include items for each reference data object and/or expectation item that has been generated. Thus, each reference data object and/or expectation item may be represented in the expectation tree 705, and the expectation tree 705 may be generated using the reference data objects and expectation items (e.g., the reference data objects and/or expectation items are used to populate the expectation tree data structure 705.

Graphical indicators 706 may be used to indicate the status of the expectations in the expectation tree data structure 705, where the status is based on whether or not a reference data object or expectation item has been linked to an engineering requirement. For example, FIG. 7A illustrates an example in which the expectation associated with Document 1, Section A, Part 2 (e.g., an aircraft regulation document file) has not been linked to an engineering requirement, while all other expectation items have been linked to engineering requirements. Thus, the graphical indicator 706-2 has an “x,” indicating that it has not been linked, while the other graphical indicators (e.g., the indicator 706-1) has a check mark, indicating that it has been linked. The graphical indicators 706 may be responsive to the hierarchical organization of the expectation tree data structure 705. For example, the status of a node may determine the status of all nodes directly above that node. Thus, because an expectation in Document 1 has not been linked to an engineering requirement, the graphical indicator 706 for the parent node of Document 1 indicates that status (e.g., the “x” indicating the lack of a link to one of the expectations in that document). In this way, a user can easily visualize and identify expectations that are missing links to engineering requirements, and can easily expand and/or collapse the nodes of the expectation tree data structure to navigate through the various expectation items. Further, the nodes of the expectation tree data structure 705 may act as links, such that a selection of one of the nodes (or an associated input object) will cause the reference data object associated with the selected node to be displayed to the user.

FIGS. 7B-7C illustrate how the system may be used to analyze how changes to either expectations or to engineering requirements affect the validation and/or compliance of an aircraft design. Such analysis may be initiated by a user selection of a revision audit option 710 (FIG. 7A), or any other suitable user interface operation. FIG. 7B illustrates the user interface 700 displaying an expectation tree 714 showing the hierarchical view of the expectations captured by the reference data objects and expectation items, and a requirement object tree 716 showing the hierarchical view of the engineering requirements of the aircraft design. This user interface may be used to illustrate how actual changes in the system data affect other data objects. For example, if an expectation item has been changed by a user (e.g., due to the underlying expectation having been changed), the user interface can allow users to quickly and easily visualize (and navigate to) the engineering requirements that are affected by the change. The user interface may also be used to predict how a hypothetical change to the system data affects other data objects. For example, if a user is considering changing an engineering requirement, the user interface 700 may allow the user to select the engineering requirement under consideration and quickly and easily visualize (and navigate to) the expectation items that would be affected by the change.

FIG. 7B illustrates the effect of an actual or hypothetical change in a reference data object or expectation item. In response to detecting an actual change in that node (as indicated by the graphical object 715), or in response to a user selection of that node (e.g., such as by manually selecting the node, indicated by graphical object 715), the system may analyze the system data to determine which engineering requirements are affected by that change, such as by analyzing the links between the expectation item and the engineering requirements. The engineering requirements that are affected may be indicated graphically, such as with boxes 717 or any other suitable graphical indication. As noted above, the status of a child node affects the status of its parent nodes. Thus, if a child node is affected by an expectation or engineering requirement change, a graphical indication is provided for the parent node to assist users in locating and navigating to the affected child nodes. Stated another way, a parent node is only indicated to be unaffected if all of its child nodes are unaffected.

Returning to the example of FIG. 7B, the node for Document 1, Section A has been selected in the expectation tree 714, indicating that the reference data object and/or expectation item associated with that node has been changed (or a change to that node is being investigated). As a result, the system analyzes the system data, including the links associated with the expectation items that refer to Document 1, Section A (see, e.g., FIG. 5E), and determined that engineering requirements 2.1.2.1. and 2.1.2.2. would be affected by the change. As noted above, these nodes may act as links, such that the user can select the text or other input object associated with the nodes to cause the corresponding expectation item and/or engineering requirement to be displayed.

FIG. 7C illustrates an example in which the proposed or actual change is to an engineering requirement, rather than an expectation item. For example, the node 719 for engineering requirement 2.1.2.2. has been selected in the requirement object tree 716, indicating that the engineering requirement associated with that node has been changed (or a change to that node is being investigated). As a result, the system analyzes the system data, including the links associated with the engineering requirement 2.1.2.2. (see, e.g., FIG. 6C), and determined that the expectation item associated with Document 1, Section A, part 2 (node 721) would be affected by the change (see, e.g., FIG. 6D). As noted above, these nodes may act as links, such that the user can select the text or other input object associated with the nodes to cause the corresponding expectation item and/or engineering requirement to be displayed.

FIGS. 7A-7C illustrate example graphical indications to signify that a node has changed (e.g., an “x” in a box) and/or is affected by a change (e.g., bold font and a box around the text of the node. These are merely examples, however, and other graphical indications may be used instead of or in addition to those shown in FIGS. 7A-7C.

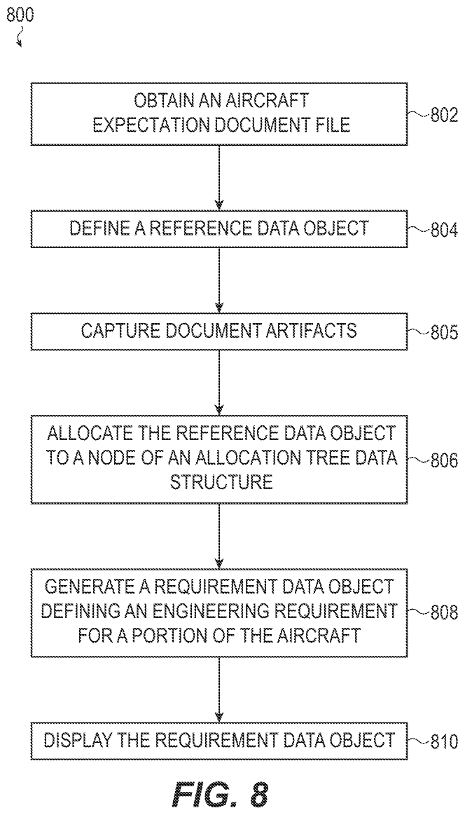

FIG. 8 is a flow chart of an example process 800 for generating and linking reference data objects and engineering requirement data objects for analyzing compliance of an aircraft design with stakeholder expectations. The process 800 may be performed by devices and/or services of the system 200, including the reference data object system 202, the engineering requirement system 206, and/or other server computer system(s), client computer system(s), cloud-based computing system(s), and the like.

At operation 802, an aircraft expectation document file is obtained. The aircraft expectation document file may be a file corresponding to a document that contains aircraft regulations, laws, guidelines, instructions, or other expectations with which an aircraft design is desired to comply. The aircraft expectation document file may be in an immutable, non-editable format, or the system may otherwise prevent users (e.g., users without sufficient permissions) from modifying or editing the aircraft expectation document file. The aircraft expectation document file may be stored in any suitable format, such as an image format, portable document format, text-based format, or the like.

At operation 804, a reference data object may be defined. The reference data object may be stored in a database in the system.

At operation 805, document artifacts may be captured. Capturing a document artifact may include receiving a designation of a location within the aircraft expectation document file, the location corresponding to selected immutable expectation content within the aircraft expectation document file. The designation of the location may be received in a graphical user interface that includes an image of the aircraft expectation document file. The designation of the location may be received via a document portion capture control, such as a screen-capture tool that allows a user to identify a selected region of the displayed aircraft expectation document file (e.g., a rectangle or other shape around the target text of the aircraft expectation document file). The designation of the location may be a location (e.g., coordinates) of the immutable expectation content within the aircraft expectation document file. In some cases, the designation of the location may be used to capture an image file corresponding to the selected region of the aircraft expectation document file. For example, a user may use a screen-capture tool to identify a portion of an aircraft expectation document file (e.g., to define an area around the desired portion of the file), and an image (e.g., a .jpeg, .tiff, .png, or any other suitable file format) corresponding to that area may be captured and stored in association with the reference data object. In cases where an image of the area is captured, the reference data object may include an address, storage location, or other identifier of the image. In cases where an image file of the area is not captured, the reference data object may include information corresponding to the location of the target immutable expectation content (e.g., coordinates defining the area within the document). FIGS. 5A-5E illustrate an example of a designation of a location in an aircraft expectation document file being received.

Defining the reference data object may also include receiving information defining an expectation item associated with the immutable expectation content at the location within the aircraft expectation document file. For example, a user may enter information about the immutable expectation content, such as a title, an analysis or summary of the expectation content, or the like.

Defining the reference data object may also include assigning a reference data object identifier to the reference data object, and assigning an expectation item identifier to the expectation item of the reference data object. The identifiers may be unique strings, addresses, or other data that identifies the reference data object and/or the expectation item in the system, as described with respect to FIGS. 3, 5B, and 5D. The operations involved in defining a reference data object are also discussed with respect to the reference data object user interface in FIGS. 3-5E.

At operation 806, the reference data object may be allocated to a node of an allocation tree data structure. Allocating the reference data object to the node may include obtaining a node identifier of the node of the allocation tree data structure (e.g., via user selection in an allocation tree data structure displayed in a graphical user interface, as shown in FIG. 5C), where the node defines an operational objective of an aircraft. The reference data object may be generated, modified, and/or updated to include the selected node identifier. In some cases, the reference data object is also generated, modified, and/or updated to include information associated with the selected node, such as a title or other text associated with the node.

At operation 808, a requirement data object is generated, the requirement data object defining an engineering requirement for a portion of the aircraft. Generating the requirement data object may include causing display of a requirement data object generation user interface on a client device (e.g., as shown in FIGS. 6A-6C), receiving a selection of the node of the allocation tree data structure (e.g., a user selection of the selectable element 606-1 in FIGS. 6A and 6C), and in response to receiving the selection of the node, cause display of a list of candidate expectation items (and/or reference data objects) from reference data objects associated with the selected node (e.g., in a link selection region 623 in FIG. 6C). In response to receiving a selection of the expectation item, a link to the expectation item (and/or to the reference data object that includes the expectation item) may be stored in the requirement data object and/or the requirement data object is generated or modified to include the link.

Requirement content may also be received from the user, including, for example, a summary of the engineering requirement, engineering or technical specifications, materials, components, or other suitable information. The received requirement content may also be stored in the requirement data object. In some cases, in response to detecting the user selection of the expectation item (and/or reference data object) for inclusion in the requirement data object, the expectation item (and/or reference data object) may be modified to include a link to the requirement data object.

As described herein, multiple reference data objects (each including zero or more expectation items) may be generated. Further, reference data objects and expectation items may be generated for multiple aircraft expectation document files.

At operation 810, the requirement data object may be displayed in response to receiving a user request to display the requirement data object. For example, the user may request to view the requirement data object to review the expectation items that it has been linked to. Displaying the requirement data object may include displaying the requirement content (e.g., a summary of the engineering requirement, engineering or technical specifications, materials, components, etc.), and displaying the requirement data object's links to expectation items (e.g., the link or links that were included in the requirement data object). FIG. 6A illustrates an example requirement data object displayed in a graphical user interface, including both requirement content and a link to an expectation item. As described herein, the link is selectable to cause display of the reference data object that includes the linked expectation item. FIG. 6D, for example, illustrates the reference data object to which the requirement data objects in FIGS. 6A and 6C include links. For example, selection of the link 622 may cause the reference data object shown in FIG. 6D to be displayed.

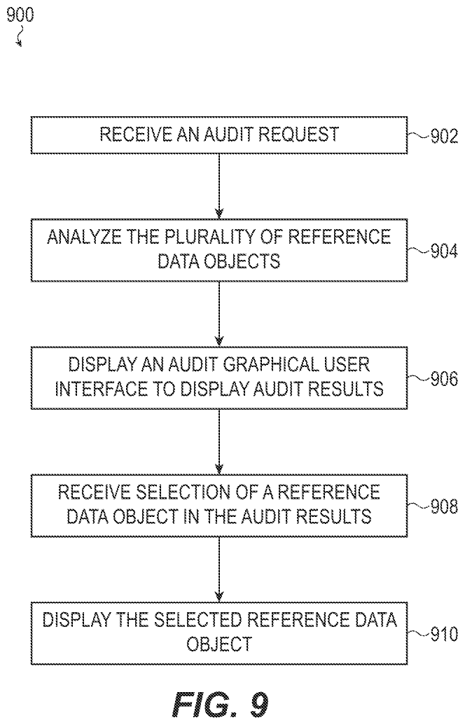

FIG. 9 is a flow chart of an example process 900 for analyzing compliance of an aircraft design with stakeholder expectations. The process 900 may be performed by devices and/or services of the system 200, including the reference data object system 202, the engineering requirement system 206, and/or other server computer system(s), client computer system(s), cloud-based computing system(s), and the like.

At operation 902, an audit request is received, the audit request configured to evaluate compliance with one or more aircraft expectation document files (e.g., aircraft expectation document files for which reference data objects and requirement data objects have been generated and linked). The audit request may be generated in response to a hypothetical change to a requirement data object or a reference data object (or an underlying expectation item or expectation), or in response to the system detecting an actual change to expectations (e.g., detecting a change to an aircraft expectation document file or a new aircraft expectation document file being uploaded to the system).

At operation 904, in response to receiving the audit request, the reference data objects are analyzed. The analysis may include identifying reference data objects (and/or expectation items) that are not associated with any requirement data objects. As described herein, reference data objects and/or expectation items that are not linked to a requirement data object may indicate that an expectation has not been addressed in the design of the aircraft, and that there may be an issue with compliance that needs to be investigated or otherwise addressed.

At operation 906, an audit graphical user interface may be displayed. The audit graphical user interface may include a graphical output identifying the reference data objects that are not associated with any requirement data objects. For example, FIG. 7A illustrates an example audit graphical user interface in which reference data objects (and/or expectation items) that lack links to requirement data objects. Other audit graphical user interfaces may also be displayed to illustrate other audit results, such as to indicate what requirement data objects are impacted by changes in expectations, and/or what reference data objects are impacted by changes to requirement data objects. For example, an indication may be received that immutable expectation content associated with a reference data object has changed. In response to receiving the indication (which may be automatically generated or user-supplied), the system analyzes the system data and identifies a set of one or more requirement data objects affected by the change in the immutable expectation content, and graphically indicates, to the user, the set of requirement data objects that are affected by the change in the immutable expectation content. FIG. 7B illustrates an example audit user interface indicating which requirement data objects are affected by a change to immutable expectation content in Document 1, Section A.

At operation 908, a selection of a reference data object in the audit results may be received. The selected reference data object may be a reference data object that was indicated as lacking a link to a requirement data object, or any other reference data object that may be displayed in the audit results.

At operation 910, in response to receiving the selection of the reference data object, the reference data object is displayed to the user. Upon a user selection of a reference data object that is indicated as lacking a link to a requirement data object (or selection of any data object in the audit user interface), the selected data object may be displayed. For example, selection of the expectation item under Document 1, Section A, Part 2 (in FIG. 7A) may cause the system to display the reference data object user interface as shown in FIG. 5D (which is the reference data object that includes the selected expectation item).

FIG. 10 illustrates a sample electrical block diagram of an electronic device 1000 that may perform the operations described herein. The electronic device 1000 may in some cases take the form of any of the electronic devices described with reference to FIGS. 2-7C, including client devices, servers or other computing devices associated with the system 200 (e.g., the reference data object system, the engineering requirement system, and/or other systems and/or devices for implementing the techniques described herein). The electronic device 1000 can include one or more of a display 1008, a processing unit 1002, a power source 1012, a memory 1004 or storage device, input devices 1006, and output devices 1010. In some cases, various implementations of the electronic device 1000 may lack some or all of these components and/or include additional or alternative components.

The processing unit 1002 can control some or all of the operations of the electronic device 1000. The processing unit 1002 can communicate, either directly or indirectly, with some or all of the components of the electronic device 1000. For example, a system bus or other communication mechanism 1014 can provide communication between the processing unit 1002, the power source 1012, the memory 1004, the input device(s) 1006, and the output device(s) 1010.

The processing unit 1002 can be implemented as any electronic device capable of processing, receiving, or transmitting data or instructions. For example, the processing unit 1002 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1000 can be controlled by multiple processing units. For example, select components of the electronic device 1000 (e.g., an input device 1006) may be controlled by a first processing unit and other components of the electronic device 1000 (e.g., the display 1008) may be controlled by a second processing unit, where the first and second processing units may or may not be in communication with each other.

The power source 1012 can be implemented with any device capable of providing energy to the electronic device 1000. For example, the power source 1012 may be one or more batteries or rechargeable batteries. Additionally or alternatively, the power source 1012 can be a power connector or power cord that connects the electronic device 1000 to another power source, such as a wall outlet.

The memory 1004 can store electronic data that can be used by the electronic device 1000. For example, the memory 1004 can store electronic data or content such as, for example, audio and video files, documents and applications, device settings and user preferences, timing signals, control signals, and data structures or databases. The memory 1004 can be configured as any type of memory. By way of example only, the memory 1004 can be implemented as random access memory, read-only memory, Flash memory, removable memory, other types of storage elements, or combinations of such devices.

In various embodiments, the display 1008 provides a graphical output, for example associated with an operating system, user interface, and/or applications of the electronic device 1000. For example, the display 1008 may display graphical user interfaces associated with the system 200, including but not limited to a reference data object user interface, a requirement data object user interface, an audit user interface, or any other graphical user interfaces or other graphical outputs described herein). In one embodiment, the display 1008 includes one or more sensors and is configured as a touch-sensitive (e.g., single-touch, multi-touch) and/or force-sensitive display to receive inputs from a user. For example, the display 1008 may be integrated with a touch sensor (e.g., a capacitive touch sensor) and/or a force sensor to provide a touch-and/or force-sensitive display. The display 1008 is operably coupled to the processing unit 1002 of the electronic device 1000.

The display 1008 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1008 is positioned beneath and viewable through a cover that forms at least a portion of an enclosure of the electronic device 1000.

In various embodiments, the input devices 1006 may include any suitable components for detecting inputs. Examples of input devices 1006 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1006 may be configured to detect one or more particular types of input and provide a signal (e.g., an input signal) corresponding to the detected input. The signal may be provided, for example, to the processing unit 1002.

As discussed above, in some cases, the input device(s) 1006 include a touch sensor (e.g., a capacitive touch sensor) integrated with the display 1008 to provide a touch-sensitive display. Similarly, in some cases, the input device(s) 1006 include a force sensor (e.g., a capacitive force sensor) integrated with the display 1008 to provide a force-sensitive display.

The output devices 1010 may include any suitable components for providing outputs. Examples of output devices 1010 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 1010 may be configured to receive one or more signals (e.g., an output signal provided by the processing unit 1002) and provide an output corresponding to the signal.

In some cases, input devices 1006 and output devices 1010 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1002 may be operably coupled to the input devices 1006 and the output devices 1010. The processing unit 1002 may be adapted to exchange signals with the input devices 1006 and the output devices 1010. For example, the processing unit 1002 may receive an input signal from an input device 1006 that corresponds to an input detected by the input device 1006. The processing unit 1002 may interpret the received input signal to determine whether to provide and/or change one or more outputs in response to the input signal. The processing unit 1002 may then send an output signal to one or more of the output devices 1010, to provide and/or change outputs as appropriate.

The instant application uses an aircraft as an example field or subject matter to which the systems and methods described herein may apply. However, it will be understood that the same system may apply to other types of vehicles and/or fields for which it is desired to adhere to or comply with regulations, laws, and other stakeholder expectations. For example, the instant systems and methods may be applied to any number of regulated vehicles, including automobiles, trains, ships, spacecraft, satellites, orbital vehicles, and the like, and in fields and industries such as aerospace, power generation, transportation (e.g., rail, automotive), shipping, shipbuilding, medicine, and the like. In such cases, it will be understood that the particular field in which the system and methods are being used will define the content of the stakeholder expectations, allocation trees, expectation items, regulation content, engineering requirements, and other objects and components described herein. Indeed, the systems and methods described can be equally applied to other fields.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

What is claimed is:

1. A method comprising, at a computing system comprising a processor and memory:
obtaining an aircraft expectation document file containing immutable expectation content;
defining a reference data object, comprising:
receiving a designation of a location within the aircraft expectation document file, the location corresponding to selected immutable expectation content within the aircraft expectation document file;
receiving information defining an expectation item associated with the selected immutable expectation content; and
assigning a reference data object identifier to the reference data object;
storing the reference data object in a database;
allocating the reference data object to a node of an allocation tree data structure, comprising:
obtaining a node identifier of the node of the allocation tree data structure, the node defining an operational objective of an aircraft; and
modifying the reference data object to include the node identifier;
generating a requirement data object defining an engineering requirement for a portion of the aircraft, comprising:
causing display of a requirement data object generation user interface on a client device;
receiving a selection of the node of the allocation tree data structure;
in response to receiving the selection of the node, causing display of a list of candidate expectation items from reference data objects associated with the node;
receiving a selection of the expectation item from the list of candidate expectation items;
in response to receiving a selection of the expectation item, storing a link to the expectation item in the requirement data object;
receiving requirement content; and
storing the received requirement content in the requirement data object; and
in response to receiving a request to view the requirement data object:
causing display of the requirement content; and
causing display of the link to the expectation item, the link selectable to cause display of the reference data object that includes the expectation item.

2. The method of claim 1, wherein:
the reference data object is a reference data object of a plurality of reference data objects;
each respective reference data object of the plurality of reference data objects is associated with respective immutable expectation content within the aircraft expectation document file; and
the method further comprises:
receiving an audit request configured to evaluate compliance with at least the aircraft expectation document file;
in response to receiving the audit request, analyzing the plurality of reference data objects to identify reference data objects that are not associated with any requirement data objects; and
causing display of an audit graphical user interface, the audit graphical user interface including a graphical output identifying the reference data objects that are not associated with any requirement data objects.

3. The method of claim 1, further comprising, in response to receiving the selection of the expectation item, storing a link to the requirement data object in the reference data object.

4. The method of claim 1, wherein:
the reference data object comprises:
the expectation item; and
the reference data object identifier; and
allocating the reference data object to the node of the allocation tree data structure comprises associating the node identifier with the expectation item.

5. The method of claim 4, wherein the reference data object further comprises at least one of:
information corresponding to the location of the selected immutable expectation content; or
an image corresponding to a portion of the aircraft expectation document file identified by the location of the selected immutable expectation content.

6. The method of claim 1, further comprising assigning an expectation item identifier to the expectation item.

7. The method of claim 1, wherein:
the expectation item is a first expectation item;
the location of the selected immutable expectation content is a first location of first selected immutable expectation content; and
defining the reference data object further comprises:
receiving a designation of a second location within the aircraft expectation document file, the second location corresponding to second selected immutable expectation content within the aircraft expectation document file; and
receiving information defining a second expectation item associated with the second selected immutable expectation content.

8. The method of claim 1, wherein:
the reference data object is a reference data object of a plurality of reference data objects;
each respective reference data object of the plurality of reference data objects is associated with respective immutable expectation content within the aircraft expectation document file;
the requirement data object is a requirement data object of a plurality of requirement data objects; and
the method further comprises:
receiving an indication that expectation content of the selected immutable expectation content associated with the reference data object has changed;
identifying a set of requirement data objects affected by the change in the expectation content; and
graphically indicating, to a user, the set of requirement data objects that are affected by the change in the expectation content.

9. A method comprising, at a computing system comprising a processor and memory:
causing display of a first graphical user interface including a document image of an aircraft expectation document;
receiving a user input identifying a selected region of the document image;
capturing data corresponding to the selected region of the document image;
causing an allocation tree data structure to be displayed in the first graphical user interface, the allocation tree data structure defining a plurality of nodes, respective nodes of the plurality of nodes corresponding to respective operational objectives of an aircraft;
in response to a user selection of a node of the allocation tree data structure, generating a reference data object that includes an identifier of the selected node and the data corresponding to the selected region of the document image;
in response to receiving a requirement data object generation request, generating a requirement data object, the requirement data object comprising an engineering requirement for a portion of the aircraft and a link to the reference data object;
causing display of the requirement data object in a second graphical user interface, the requirement data object including the link to the reference data object; and
in response to receiving a selection of the link to the reference data object, causing at least one of the reference data object or the selected region of the document image to be displayed to a user.

10. The method of claim 9, wherein:
the reference data object comprises an expectation item; and
the link to the reference data object is a link to the expectation item.

11. The method of claim 10, wherein:
the expectation item is a first expectation item;
the reference data object comprises a second expectation item;
the requirement data object is a first requirement data object;
the link to the reference data object is a link to the first expectation item; and
a second requirement data object comprises an additional engineering requirement for the portion of the aircraft and a link to the second expectation item.

12. The method of claim 10, further comprising including the link to the reference data object in the requirement data object in response to the user selecting the reference data object for inclusion in the requirement data object.

13. The method of claim 12, further comprising, in response to detecting the user selection of the reference data object for inclusion in the requirement data object, modifying the reference data object to include a link to the requirement data object.

14. The method of claim 10, wherein the data corresponding to the selected region of the document image is an image file.

15. A method comprising, at a computing system comprising a processor and memory:
causing display of a reference data object user interface, the reference data object user interface including a document image of an aircraft expectation document and a document portion capture control;
receiving, via the document portion capture control, a user selection of a region of the displayed document image, the region including immutable expectation content within the aircraft expectation document;
causing display of a node selection user interface including an allocation tree data structure defining a plurality of nodes, respective nodes of the plurality of nodes corresponding to respective operational objectives of an aircraft;
receiving a selection of a node in the allocation tree data structure;
receiving information defining an expectation item associated with the immutable expectation content;
in response to receiving the selection of the node and the information defining the expectation item, generating a reference data object including an identifier of the selected node and the information defining the expectation item;
causing display of a requirement data object user interface including a description field and a reference data object linking control;
receiving, in the description field, an engineering requirement for a portion of the aircraft;
receiving, via the reference data object linking control, a selection of an identifier associated with the expectation item;
in response to receiving the selection of the identifier associated with the expectation item, generate a link to the reference data object that includes the expectation item;
generating a requirement data object including the engineering requirement and the link to the reference data object that includes the expectation item; and
causing display of the requirement data object, including causing display of the engineering requirement for the portion of the aircraft and the link to the reference data object, wherein selection of the link is configured to cause display of at least one of the reference data object or the user selected region of the displayed document image.

16. The method of claim 15, wherein the reference data object linking control displays a list of candidate expectation items including the expectation item.

17. The method of claim 16, wherein:
the selection of the node is a first selection of the node during a reference data object generation operation; and
the method further comprises receiving a second selection of the node during a requirement data object generation operation.

18. The method of claim 17, wherein the list of candidate expectation items displayed in the reference data object linking control are selected from reference data objects associated with the selected node of the allocation tree data structure.

19. The method of claim 17, further comprising, in response to receiving the second selection of the node during the requirement data object generation operation, prepopulating the requirement data object with information from the selected node.

20. The method of claim 17, further comprising, in response to receiving the second selection of the node during the requirement data object generation operation, prepopulating the requirement data object with information from a reference data object associated with the selected node.
